(19) United States
(12) Patent Application Publication
(10) Pub. No.: US 2026/0218002 A1
(43) Pub. Date: Jul. 30, 2026

(54) THREE-DIMENSIONAL ARCHITECTED MATERIALS FOR ENERGY ABSORPTION

(71) Applicant: National Research Council of Canada, Ottawa (CA)

(72) Inventors: Kathleen Sampson, Ottawa (CA); Kurtis Laqua, Toronto (CA); Derek Aranguren van Egmond, Toronto (CA); Thomas Lacelle, Ottawa (CA); Chantal Paquet, Ottawa (CA); Hao Li, Ottawa (CA)

(21) Appl. No.: 19/150,697

(22) PCT Filed: Sep. 28, 2023
(86) PCT No.: PCT/CA2023/051285

§ 371 Date: Jul. 24, 2025

Related U.S. Application Data
(60) Provisional application No. 63/448,704, filed on Feb. 28, 2023.

(51) Int. Cl. C09D 135/02; B29C 64/118; B29C 64/30; B29C 71/00; B29C 71/02; B29K 33/00; B29K 75/00; B29K 105/00; B29K 105/24; B33Y 10/00; B33Y 40/20; B33Y 70/00; C09D 4/00; C09D 133/10; C09D 133/14

(52) U.S. Cl. CPC C09D 135/02; B29C 64/118; B29C 64/30; B29C 71/0009; B29C 71/02; B33Y 10/00; B33Y 40/20; B33Y 70/00; C09D 4/00; C09D 133/10; C09D 133/14; B29C 2071/0018; B29K 2033/12; B29K 2075/00; B29K 2105/0085; B29K 2105/24; B29K 2995/0091

(57) ABSTRACT

The present disclosure relates to a material having a three-dimensional shape. In particular, the material has a three-dimensional shape comprising a first phase and a second phase. The first phase comprises a crosslinked polymer and the second phase comprises a second polymer that is present in a concentration gradient within the crosslinked polymer to form an interpenetrating network having a concentration gradient.

### CROSS-REFERENCE TO RELATED APPLICATIONS

The present application claims the benefit of priority from co-pending U.S. Provisional Application No. 63/448,704, filed on Feb. 28, 2023, the contents of which are incorporated herein by reference in their entirety.

### FIELD

The present disclosure relates to a material having a three-dimensional shape. In particular, the material has a three-dimensional shape comprising a first phase and a second phase and having a concentration gradient interpenetrating polymer network.

### INTRODUCTION

Currently, impact attenuating materials used in protective devices are not sufficiently efficient at absorbing impact forces throughout their volume. This requires impractically thick layers of material to obtain a desired performance in protective linings of e.g. blast impact devices, personal armour and sporting equipment. There is thus a need for maintaining lightweight properties, while boasting improved mechanical properties such as strength, impact resistance, and toughness over existing technologies.

Often, impact attenuation is achieved primarily through foamed core and truss/honeycomb core sandwich panel materials. Architected materials are used to improve the deformability of the absorber while maintaining strength upon impact. These impact attenuating materials are most often composed of bending-dominated struts in a monolithic architected truss network.

Foam and truss-based attenuation materials made by traditional manufacturing techniques are heavily limited in the morphologies of their internal cellular units. Furthermore, their monolithic composition and constant architectural parameters (e.g. strut thickness, radius and length) throughout the structure prevent location-specific fine tuning of dimensions for locally graded deformation modes. As a result, large volumes of material are required for desired performance, and generally impacts cause inelastic deformation in the architectural features. This limits their utility to very few impacts.

### SUMMARY

The present disclosure relates to a three-dimensional architected material having energy absorptive properties. In particular, the disclosure is directed to a material having a three-dimensional shape comprising:
a) a first phase comprising a first crosslinked polymer; and
b) a second phase comprising a concentration gradient interpenetrating polymer network comprising the first crosslinked polymer and a second polymer, the concentration gradient interpenetrating polymer network comprising the second polymer at a decreasing concentration along at least one axis within the first phase; and
the three-dimensional shape of the material aids in energy absorption.

In one embodiment, the first crosslinked polymer has a different stiffness at low or high strain rates compared to the second polymer. In another embodiment, the first crosslinked polymer has a stiffness at low or high strain rates different than that of the second polymer by at least 5%. In one embodiment, the first crosslinked polymer is an elastomeric polymer. In another embodiment, the elastomeric polymer is a polyurethane, polysiloxane (silicone), poly(meth)acrylate, polyether, polyamide, polyester, polythiol, or a combination thereof. In one embodiment, the elastomeric polymer is an elastomeric polyurethane. In a further embodiment, the polyurethane is a urethane-based acrylate elastomer or an aromatic urethane-based acrylate elastomer. In another embodiment, the urethane-based acrylate elastomer or aromatic urethane-based acrylate elastomer is formed from Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, CN9782.

In another embodiment, the first crosslinked polymer is crosslinked with a crosslinker which is a di-, tri-, tetra-, or multifunctional (meth)acrylate, a crosslinker having vinyl moieties, a crosslinker having thiol moieties, a crosslinker having epoxy moieties, a crosslinker having amine moieties, a crosslinker having alcohol moieties, or a crosslinker having carboxylic acid moieties. In another embodiment, the crosslinker is Eberly 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, or CN9782.

In a further embodiment, the urethane-based acrylate elastomer or aromatic urethane-based acrylate elastomer contains a reactive diluent comprising Ebecryl 113, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, pentaerythritol tetraacrylate.

In one embodiment, the elastomeric polymer is a liquid crystal elastomer. In a further embodiment, the liquid crystal elastomer is formed from a precursor material comprising a liquid crystal mesogen and a chain extender. In another embodiment, wherein the liquid crystal mesogen is a diacrylate and the chain extender is a dithiol and/or amine.

In one embodiment, the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; 4-[3-[(1-oxo-2-propen-1-yl)oxy]propoxy]-1,1′-(1,4-phenylene) ester benzoic acid.

In a further embodiment, the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

In one embodiment, the second polymer is a poly(meth)acrylate, polyurethane, polysiloxane (silicone), polyether, polyamide, polyester, polythiol, or a combination thereof.

In one embodiment, the poly(meth)acrylate is formed from 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, or pentaerythritol tetraacrylate. In another embodiment, the poly(meth)acrylate is a crosslinked polymer.

In another embodiment of the disclosure, the three-dimensional shape is an architected material, a lattice composed of beams or surface elements, or a foam.

In one embodiment, the three-dimensional shape has a relative density of less than 50% (by volume).

In another embodiment, the material has an increase in toughness at densification and/or energy absorption efficiency under compression tests when compared to the random copolymer composed of the equivalent weight percent of precursor materials from the first and second polymers or a non-gradient interpenetrating polymer network.

In another embodiment, the material is for vibration damping, vibration isolation, acoustic damping, acoustic isolation, or impact attenuation.

In another embodiment, the material is an energy absorbing material.

In a further embodiment, the concentration gradient is a continuous concentration gradient.

In another embodiment, the first crosslinked polymer is a 3D-printable polymer. In a further embodiment, the 3D-printable polymer is printable through volumetric 3D printing, vat polymerization 3D printing, material jetting 3D printing, powder bed fusion, or material extrusion 3D printing.

In a further embodiment, the second phase has a thickness between about 1% and 99% of the thickness of the first phase. In one embodiment, the second phase has a thickness between about 15% and 40% of the thickness of the first phase.

In one embodiment, the concentration gradient interpenetrating polymer network is a continuous concentration gradient interpenetrating polymer network.

In a further embodiment, the first phase is adjacent to the second phase.

The present disclosure also includes a process for preparing a material having a three-dimensional shape. In one embodiment, the process comprises:
a) 3D-printing a first cross-linked polymer in the form of the three-dimensional shape to form a first phase comprising the first crosslinked polymer;
b) exposing at least a portion of the first cross-linked polymer in the form of the three-dimensional shape to a liquid precursor comprising second polymer precursors, wherein the second polymer precursors diffuse into the first cross-linked polymer to obtain the first cross-linked polymer in the form of the three-dimensional shape with a decreasing concentration gradient of the second polymer precursor in the first cross-linked polymer to form a second phase within the first phase; and
c) polymerizing the second polymer precursors to form the second polymer and to obtain the material having a concentration gradient interpenetrating polymer network.

In another embodiment, the 3D-printed first cross-linked polymer is formed by:
polymerizing and cross-linking first polymer precursors in the presence of a cross-linker and a photoinitiator, by exposing the first polymer precursors to light radiation during three-dimensional printing to obtain the first cross-linked polymer in the form of the three-dimensional shape; or
extruding first polymer precursors, in the presence of a cross-linker, through a nozzle to obtain the first crosslinked polymer in the form of the three-dimensional shape.

In another embodiment, the light radiation is UV light, visible light or near-infrared light.

In one embodiment, in step (b), the first cross-linked polymer in the form of the three-dimensional shape is soaked or immersed in the liquid precursor mixture.

In another embodiment, the second polymer precursors in step (c) are polymerized by exposing to radiation. In one embodiment, the radiation is heat or light radiation.

In another embodiment, the first crosslinked polymer has a different stiffness at low or high strain rates compared to the second polymer. In a further embodiment, the first crosslinked polymer has a stiffness at low or high strain rates different than that of the second polymer by at least 5%.

In another embodiment, the first crosslinked polymer is an elastomeric polymer. In a further embodiment, the elastomeric polymer is a polyurethane, polysiloxane (silicone), poly(meth)acrylate, polyether, polyamide, polyester, polythiol, or a combination thereof. In another embodiment, the elastomeric polymer is an elastomeric polyurethane. In one embodiment, the polyurethane is a urethane-based acrylate elastomer or an aromatic urethane-based acrylate elastomer. In a further embodiment, the urethane-based acrylate elastomer or aromatic urethane-based acrylate elastomer is formed from Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, CN9782.

In one embodiment, the crosslinker is a di-, tri-, tetra-, or multifunctional (meth)acrylate, a crosslinker having vinyl moieties, a crosslinker having thiol moieties, a crosslinker having epoxy moieties, a crosslinker having amine moieties, a crosslinker having alcohol moieties, or a crosslinker having carboxylic acid moieties. In another embodiment, the crosslinker is Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, or CN9782.

In another embodiment, the urethane-based acrylate elastomer or aromatic urethane-based acrylate elastomer contains a reactive diluent comprising Ebecryl 113, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, pentaerythritol tetraacrylate.

In one embodiment, the elastomeric polymer is a liquid crystal elastomer. In another embodiment, the liquid crystal elastomer is formed from a precursor material comprising a liquid crystal mesogen and a chain extender. In a further embodiment, the liquid crystal mesogen is a diacrylate and the chain extender is a dithiol and/or amine.

In one embodiment, the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; or 4-[3-[(1-oxo-2-propen-1-yl)oxy]propoxy]-1,1′-(1,4-phenylene) ester benzoic acid.

In a further embodiment, the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

In one embodiment, the second polymer precursors are monomers of the second polymer. In a further embodiment, the second polymer is a poly(meth)acrylate, polyurethane, polysiloxane (silicone), polyether, polyamide, polyester, polythiol, copolymers thereof or combinations thereof. In a further embodiment, the poly(meth)acrylate is formed from 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, or pentaerythritol tetraacrylate.

In one embodiment, the poly(meth)acrylate is a crosslinked polymer.

In another embodiment, the three-dimensional shape is an architected material, a lattice composed of beams or surface elements, or a foam.

In one embodiment, the three-dimensional shape has a density of less than 50% (by volume).

In one embodiment, the material is for vibration damping, vibration isolation, acoustic damping, acoustic isolation, or impact attenuation. In a further embodiment, the material is an energy absorbing material.

In another embodiment, the concentration gradient interpenetrating polymer network is a continuous concentration gradient interpenetrating polymer network.

In one embodiment, the 3D-printable polymer is printable through volumetric 3D printing, vat polymerization 3D printing, material jetting 3D printing, powder bed fusion, or material extrusion 3D printing.

Other features and advantages of the present application will become apparent from the following detailed description. It should be understood, however, that the detailed description and the specific examples while indicating preferred embodiments of the application are given by way of illustration only, since various changes and modifications within the spirit and scope of the application will become apparent to those skilled in the art from this detailed description.

### BRIEF DESCRIPTION OF THE DRAWINGS

The present disclosure will now be described in greater detail with reference to the drawings in which:

FIG. 1 is a schematic representation of a method of forming an interpenetrating polymer network (IPN) within a 3D printed lattice.

FIG. 2 shows a) Fluorescence microscopy images of the cross-sections of interpenetrating polymer network (IPN) rods with 2-hydroxyethyl methacrylate (HEMA) and 1,6-hexanediol diacrylate (HDDA) as the second polymer, showing increasing thickness of the IPN second phase with increasing immersion time between 5 and 60 min. in one aspect of the disclosure; b) Diffusion ratio of HEMA second polymer into first polymer (Ebecryl rods, length 10 mm, width 4 mm, and thickness 1 mm) calculated from thickness of IPN second phase with fluorescent dye in fluorescence microscopy images with different immersion times in one aspect of the disclosure; c) Increase in weight percent (wt %) of the second polymer (HEMA circles and HDDA squares) with increasing immersion time for rods with a diameter of 1.25 mm (length of 12 mm). Percent change in dimensions of IPN rods compared to original first polymer (Ebecryl) 1.25 mm diameter rods in terms of d) length and e) diameter with increasing immersion time in HDDA and HEMA in one aspect of the disclosure;

FIG. 3 shows fluorescence microscopy images of the cross-sections of IPN rods with HEMA and HDDA as the second polymer, showing increasing thickness of the IPN second phase with increasing immersion time between 15 min and 2 days in one aspect of the disclosure;

FIG. 4 are graphs showing a) Change in weight percent (wt %) of secondary polymer (HEMA circles and HDDA squares) as a function of original design file rod diameter (fixed length of 24 mm) with an immersion time of 15 min. in one aspect of the disclosure. Percent change in dimensions of IPN rods compared to original first polymer (Ebecryl) rods in terms of b) length and c) diameter as a function of original design file rod diameter in one aspect of the disclosure.

FIG. 5 is a graph showing tensile tests of rectangular rods composed of first crosslinked polymer (Ebecryl), concentration gradient interpenetrating polymer network with HEMA as the second polymer, concentration gradient interpenetrating polymer network with HDDA as the second polymer, and a copolymer of HDDA and Ebecryl in one aspect of the disclosure.

FIG. 6 shows compression test stress-strain curves for a) Kelvin lattices composed of Ebecryl as the first crosslinked polymer immersed in HEMA second polymer precursor, b) Octet lattices composed of Ebecryl as the first crosslinked polymer immersed in HDDA second polymer precursor, and c) Kelvin lattices composed of Formlabs Flexible 80A as the first crosslinked polymer immersed in HEMA second polymer precursor (see Table 2) in one aspect of the disclosure;

FIG. 7 shows compression test stress-strain curves for Kelvin and octet lattices composed of only HDDA as the first crosslinked polymer.

FIG. 8 shows a) Compression test stress-strain curves and b) toughness at densification for Kelvin lattices immersed in HEMA second polymer precursor material for 15 min and cured with varying conditions (constant 405 nm cure at 45° C. for 60 min, constant 405 nm cure at 60° C. for 60 min, and 1000 UV flashes). C) and d) as in a) and b), but immersed in HDDA second polymer precursor material and cured with varying conditions (constant 405 nm cure at 45° C. for 60 min, constant 405 nm cure at 65° C. for 60 min, and 1000 UV flashes) (see Table 3) in one aspect of the disclosure.

FIG. 9 shows compression test stress-strain curves and mechanical properties with different lattice unit cell type and secondary polymers comparing first crosslinked polymer (Ebecryl, solid line), IPN (dotted line), and copolymer (dashed line). The lattice parameters tested are HEMA (a and b, solid bar plots in e and f) and HDDA (c and d, hashed bar plots in e and f) as the second polymer immersed for 15 min and Kelvin (a, c, and e) and Octet (b, d, and f) lattice unit cells (see Table 4) in one aspect of the disclosure.

FIG. 10 shows compression test stress-strain curves for Kelvin and Octet lattices with HEMA and HDDA IPNs (solid line) compared to the first crosslinked polymer (Ebecryl, dotted line) and the equivalent copolymer (- - dashed line) lattices as well as the Ebecryl and copolymer lattices scaled to similar dimensions as the IPN lattices (-- dashed and - -- dashed lines, respectively) (see Table 5) in one aspect of the disclosure;

FIG. 11 shows a) Multi-scale hierarchical lattice designs of Octet-Octet (left image) and Kelvin-Octet (right image) lattices with and without HEMA IPN (left and right lattices in each image, respectively) b) Stress-strain curves from compression tests of Kelvin-Octet and Octet-Octet (00) hierarchical lattices composed of FormLabs Flexible 80A polymer HEMA IPN. c) Stress-strain curves from compression tests of 2×2×2 Schwarz lattices composed of Ebecryl first polymer with and without HEMA IPN (see Table 6) in one aspect of the disclosure;

FIG. 12 shows stress-strain curves from compression tests on a) Kelvin and b) Octet lattices composed of soft urethane polymer (Ebecryl) with and without HEMA IPN, varying the number of unit cells per area from 2×2×2 to 7×7×7 (Kelvin) or to 4×4×4 (Octet) (see Table 7) in one aspect of the disclosure;

FIG. 13 shows stress-strain curves from compression tests on Kelvin lattices composed of soft urethane polymer (Ebecryl) with and without HEMA, hydroxypropyl methacrylate (HPMA), or hydroxybutyl methacrylate (HBMA) IPN cured at 65° C. for 60 min (see Table 8).

FIG. 14 shows stress-strain curves from compression tests on a) Kelvin and b) Octet lattices composed of soft urethane polymer (CN973J75, Ebecryl 242N, or CN9021) with and without HEMA or HDDA as the second polymer in the IPN (see Table 9) in one aspect of the disclosure.

### DESCRIPTION OF VARIOUS EMBODIMENTS

### Definitions

Unless otherwise indicated, the definitions and embodiments described in this and other sections are intended to be applicable to all embodiments and aspects of the present disclosure herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present disclosure, the singular forms “a”, “an” and “the” include plural references unless the content clearly dictates otherwise. For example, an embodiment including “a compound” should be understood to present certain aspects with one compound, or two or more additional compounds.

In embodiments comprising an “additional” or “second” component, such as an additional or second compound, the second component as used herein is chemically different from the other components or first component. A “third” component is different from the other, first, and second components, and further enumerated or “additional” components are similarly different.

As used in this disclosure and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The present description refers to a number of chemical terms and abbreviations used by those skilled in the art. Nevertheless, definitions of selected terms are provided for clarity and consistency.

The terms “about”, “substantially” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “material” as used herein refers to a polymeric material having a three-dimensional shape. In some examples, such a material may aid or improve energy absorption such as impact attenuation.

The term “three-dimensional shape” as used herein refers to shapes with a width, height and a depth. In some examples, such a three-dimensional shape may specifically improve the energy absorption of the material.

The term “first cross-linked polymer” as used herein refers to any polymer comprised of chains of repeating monomeric units in which the chains are bonded or cross-linked together.

The term “second polymer” as used herein refers to a polymer which is interlaced into the first polymer forming the interpenetrating polymer network.

The term “interpenetrating polymer network” (IPN) as used herein refers to a polymeric material comprising two or more different polymer networks which are at least partially interlaced on a molecular scale of size and dimensions. In some examples, such an IPN may have essentially no covalent bonds between the different polymer networks.

The term “concentration gradient” as used herein, as it refers to the IPN, refers to the amount of second polymer as a function of position along at least one axis or direction within the first polymer, resulting in a gradient of physical and/or chemical properties. This is determined by the ability of the second polymer precursors to diffuse through the first polymer and the point at which diffusion is stopped, such stoppage point/time in the diffusion process being before equilibrium is reached (complete diffusion of the secondary polymer precursors into the first polymer), whereby a decreasing amount of the secondary polymer precursors are found throughout the depth of the first polymer.

The term “continuous concentration gradient” as used herein refers to a concentration gradient in which the concentration of the second polymer continuously decreases along an axis of the first polymer without a phase boundary (i.e. no interface). It is also contemplated that in some examples, the concentration gradient or profile of the second polymer (within the first polymer) need not be continuous, for example, the gradient may be stepwise, and the like.

The term “strain rate” as used herein refers to the change in strain or deformation overtime during a mechanical test (i.e. tensile, bending, or compression testing).

The term “stiffness” as used herein refers to the degree to which deflection or deformation is resisted with an applied force. It is complementary to flexibility in that a low stiffness material has high flexibility.

The term “elastomeric polymer” as used herein refers to a polymer that has weak intermolecular forces, has a glass transition temperature below room temperature, is lightly crosslinked, is amorphous, and displays both viscous and elastic properties under deformation, such as low Young's modulus, low stiffness, high flexibility, and high elongation at break (high failure strain).

The term “architected material” as used herein refers to materials in periodic, graded, or stochastic cellular structures composed of surface and/or beam elements combined with open spaces designed to impart properties not achievable with the individual materials. In one embodiment, it is the chemistry and structure that contribute to its overall properties, and the structure design may have hierarchy with multi-scale cellular topology. An example of an architected material is a lattice. Lattices are cellular materials with repeated patterns or unit cells contained in a certain volume and comprise of beams, plates, or surfaces that are arranged in an ordered or random pattern.

The term “relative density” as used herein refers to the ratio of the density (mass per unit volume) of the three-dimensional architected material to the density of a full block of the material without open spaces and a cellular structure and is expressed as a percentage or ratio, with 1.0 being no architected material design or open spaces.

### Three-Dimensional Materials

The present disclosure relates to three-dimensional materials having improved energy absorption properties comprising a first cross-linked polymer and a second polymer. In particular, the three-dimensional materials are comprised of an interpenetrating polymer network having a concentration gradient of the second polymer in the first cross-linked polymer.

In one embodiment, the 3D shapes comprising the interpenetrating polymer networks (IPNs) (such as lattices) have spatial gradients in their material properties. The gradients in material properties include properties such as stiffness, elastic modulus, hydrophobicity, hydrophilicity, strength, resilience to biodegradation, thermal conductivity, and refractive index. In one embodiment, the materials can be used as a coating for protection against corrosion, improve the dampening of acoustic waves or forming metamaterials that can be used to manipulate electromagnetic waves with graded permittivity or refractive indices.

In embodiments of the disclosure, the material comprises, for example, lattices with IPN morphology to improve energy absorption, such as impact resistance. For example, architected materials, such as lattices, in which the material is composed of IPNs and have lattice features (e.g. struts) with variable material stiffness, resulting in materials and structures capable of repeatable, cyclic re-loading for multi-hit impact attenuation. In further embodiments, the architected materials have improved energy absorption and are single use materials with the material breaking or degrading after an initial impact. In another embodiment, the architected material is a material with hierarchical architectures with multi-scale cellular topology.

Accordingly, in one embodiment, the present disclosure is directed to a material having a three-dimensional shape comprising:
a) a first phase comprising a first cross-linked polymer; and
b) a second phase comprising a concentration gradient interpenetrating polymer network comprising the first crosslinked polymer and a second polymer, the concentration gradient interpenetrating polymer network comprising the second polymer at a decreasing concentration along at least one axis or direction within first phase; and
   the three-dimensional shape of the material aids in energy absorption.

In one embodiment, the first crosslinked polymer has a different stiffness at low or high strain rates compared to the second polymer. In one embodiment, the first and second polymers have a difference in stiffness that may or may not depend on the rate of material deformation (strain rate). In another embodiment, the first crosslinked polymer has a stiffness at low or high strain rates different than that of the second polymer by at least 5% (percent difference). In another embodiment, the first crosslinked polymer has a stiffness at low or high strain rates different than that of the second polymer in a range of about 10% to about 500%, or about 50% to about 400%, or about 100% to about 300% (percent difference). In one embodiment, for example, the first cross-linked polymer and the second polymer have a difference in stiffness at low or high strain rates of over 2,000 MPa, or over 1,000 MPa, or over 500 MPa, or over 100 MPa, or over 10 MPa.

In another embodiment, the first crosslinked polymer is an elastomeric polymer. In a further embodiment, the elastomeric polymer is a polyurethane, polysiloxane (silicone), poly(meth)acrylate, polyether, polyamide, polyester, polythiol, copolymers thereof or combinations thereof. In one embodiment, the elastomeric polymer is an elastomeric polyurethane. In another embodiment, the polyurethane is a urethane-based acrylate elastomer or an aromatic urethane-based acrylate elastomer. In a further embodiment, the urethane-based acrylate elastomer or aromatic urethane-based acrylate elastomer is formed from Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, CN9782 and are supplied from Allnex® or Sartomer® or Formlabs®.

In another embodiment of the disclosure, the first crosslinked polymer is crosslinked with a crosslinker which is a di-, tri-, tetra-, or multifunctional (meth)acrylate, a crosslinker having vinyl moieties, a crosslinker having thiol moieties, a crosslinker having epoxy moieties, a crosslinker having amine moieties, a crosslinker having alcohol moieties, or a crosslinker having carboxylic acid moieties. In another embodiment, the crosslinker is Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, or CN9782.

In a further embodiment, the urethane-based acrylate elastomer or aromatic urethane-based acrylate elastomer contains a reactive diluent comprising Ebecryl 113, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, pentaerythritol tetraacrylate.

In another embodiment of the disclosure, the elastomeric polymer is a liquid crystal elastomer. In one embodiment, the liquid crystal elastomer is formed from a precursor material comprising a liquid crystal mesogen and a chain extender. In another embodiment, the liquid crystal mesogen is a diacrylate and the chain extender is a dithiol and/or amine. In a further embodiment, the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; 4-[3-[(1-oxo-2-propen-1-yl)oxy]propoxy]-1,1′-(1,4-phenylene) ester benzoic acid. In another embodiment, the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

In another embodiment of the disclosure, the second polymer is a poly(meth)acrylate, polyurethane, polysiloxane (silicone), polyether, polyamide, polyester, polythiol, copolymers thereof or combinations thereof.

In another embodiment, the poly(meth)acrylate is formed from 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, or pentaerythritol tetraacrylate.

In one embodiment, the poly(meth)acrylate is a crosslinked polymer.

In another embodiment, the three-dimensional shape is an architected material, a lattice composed of beams or surface elements, or a foam. In one embodiment, the types of lattices include triple periodic minimal surface (TPMS)-, beam-, honeycomb-, and plate-based. Examples of unit cells in beam-based lattices include simple cubic, body centred cubic, face centred cubic, diamond, fluorite, octet, truncated cube, truncated octahedron, Kelvin, isotruss, re-entrant, or Weaire-Phelan. In another embodiment, the three-dimensional shape is a sheet, filament or fiber.

In a further embodiment, the three-dimensional shape has a relative density of less than 50%. In one embodiment, the three-dimensional shape has a relative density of less than 50% and is a functional architected material having energy absorptive properties.

In another embodiment, the material has an increase in toughness at densification and/or energy absorption efficiency under compression tests when compared to the random copolymer composed of the equivalent weight percent of precursor materials from the first and second polymers or a non-gradient interpenetrating polymer network.

In a further embodiment, the material is for vibration damping, vibration isolation, acoustic damping, acoustic isolation, or impact attenuation.

In another embodiment, the material is an energy absorbing material.

In another embodiment, the concentration gradient is a continuous concentration gradient, whereby the IPN has no phase boundary between the first phase and the second phase or polymer. In one embodiment, a continuously decreasing amount of second polymer precursors are able to diffuse or penetrate deeper or farther into the first cross-linked polymer. In one embodiment, for example, the lack of a phase boundary between the intertwined polymer networks results in resilient three-dimensional shapes (such as struts in lattices) with recoverable properties that do not depend on fracture of the stiff phase.

In one embodiment, the concentration gradient interpenetrating polymer network is a continuous concentration gradient interpenetrating polymer network. Generally, in one embodiment, the concentration gradient IPN decreases continuously along one axis or direction of the first phase, and generally in the direction in which the second polymers diffused. For example, the first phase will have a three-dimensional shape and the three-dimensional shape will have a surface which will be in contact with the second polymer precursors which will diffuse into the first phase along the axis or direction of diffusion resulting in the continuous concentration gradient interpenetrating polymer network. In one embodiment, by diffusing into the first polymer, the second polymer precursors form the second polymer (once polymerized) which is interlaced within the first polymer forming the interpenetrating polymer network.

In one embodiment, the continuous concentration gradient interpenetrating polymer network is for example, a core-shell continuous interpenetrating polymer network. In one embodiment, the first crosslinked polymer is a 3D-printable polymer having a three-dimensional shape, such as lattice structure with struts that have a core of a first cross-linked polymer and an outer shell of an IPN made of the first cross-linked polymer and a second polymer. In one embodiment, if the whole lattice structure is soaked to equilibrium in the second polymer precursors, the stiffness of the lattice will be uniform. In another embodiment, if only a portion of the lattice is soaked in the second polymer precursors or soaking is terminated before equilibrium is reached in the whole lattice structure, the stiffness of the lattice struts will vary spatially. For example, in one embodiment, the core (or the first phase) has lower stiffness and the shell (or the second phase) has a higher stiffness. In one embodiment, the IPN comprises a continuum between hard and soft phases that together provide high toughness and failure resistance, without a major compromise in stiffness or strength. In one embodiment, for a strut-based lattice material, the IPN is a graded composition of the struts, with a core-shell morphology. For example, in one embodiment, the stiffer polymer phase (the shell or second phase) forms a strong, rigid shell that places the load-bearing material away from the neutral bending axis of each strut. In a further embodiment, contained within the core (the core or first phase) is a softer elastomeric phase, which helps to damp the impact energy and provides shape recovery and energy return to the beam. In another embodiment, the core (or the first phase) has a higher stiffness and the shell (or the second phase) has a lower stiffness. For example, in one embodiment, the stiffer polymer phase (the core or first phase) forms a strong, rigid core, and a second softer elastomeric phase as a shell.

In a further embodiment, the 3D-printable polymer is printable through volumetric 3D printing, vat polymerization 3D printing, material jetting 3D printing, powder bed fusion, material extrusion 3D printing, and the like.

In one embodiment, the second phase has a thickness between about 1% and 99% of the thickness of the first phase. In another embodiment, the second phase has a thickness between about 15% and 40% of the thickness of the first phase.

In one embodiment, the material of the present disclosure having a three-dimensional shape is useful for energy absorption and impact attenuation, for example, in helmets, crash protection for vehicles, blast impact, protective armour, playground or protective flooring surfaces, bioscaffolds or thermal management in heat exchangers.

### Process for Preparing Materials

The present disclosure is also directed to a process for preparing the material having a three-dimensional shape. The process comprises three-dimensionally printing a first cross-linked polymer into a desired shape and exposing at least a portion (or all) of the shape to second polymer precursors which diffuse into the first-cross-linked polymer resulting in the concentration gradient interpenetrating polymer network. Accordingly, in one of embodiment, the present disclosure includes a process for preparing a material having a three-dimensional shape, the process comprising:
a) 3D-printing a first cross-linked polymer in the form of the three-dimensional shape to form a first phase comprising the first crosslinked polymer;
b) exposing at least a portion of the first cross-linked polymer in the form of the three-dimensional shape to a liquid precursor comprising second polymer precursors, wherein the second polymer precursors diffuse into the first cross-linked polymer to obtain the first cross-linked polymer in the form of the three-dimensional shape with a decreasing concentration gradient of the second polymer precursor in the first cross-linked polymer to form a second phase within the first phase; and
c) polymerizing the second polymer precursors to form the second polymer and to obtain the material having a concentration gradient interpenetrating polymer network.

In one embodiment, the 3D-printed first cross-linked polymer is formed by:
i) polymerizing and cross-linking first polymer precursors in the presence of a cross-linker and a photoinitiator, by exposing the first polymer precursors to light radiation during three-dimensional printing to obtain the first cross-linked polymer in the form of the three-dimensional shape; or
ii) extruding first polymer precursors, in the presence of a cross-linker, through a nozzle to obtain the first crosslinked polymer in the form of the three-dimensional shape.

In another embodiment, the light radiation in step (i) is UV light, visible light or near-infrared light.

In another embodiment, in step (b), the first cross-linked polymer in the form of the three-dimensional shape is soaked or immersed in the liquid precursor mixture. In one embodiment, the first cross-linked polymer in the form of the three-dimensional shape is immersed or soaked partly or fully in the liquid precursor mixture, which results in the second polymer precursors diffusing into the first-cross-linked polymer.

In one embodiment, the liquid precursor comprising the second polymer precursors is a liquid precursor mixture comprising the second polymer precursors, and for example, a photoinitiator.

In one embodiment, the mechanical properties of the materials having a three-dimensional shape (such as a lattice) is varied to a desired property based on the selection of the first-cross-linked polymer and the second polymer and their mechanical properties, degree of cross-linking, as well as the degree of diffusion (soaking or immersion time) and polymerization of the polymers (light dose). In particular, in one embodiment, the stiffness, strength, elongation at failure, and energy absorption (toughness) of the materials can be varied based on a selection of these variables.

In one embodiment, the second polymer precursors in step (c) are polymerized by exposing the precursors to radiation. In a further embodiment, the radiation in step (c) is heat or light radiation.

In one embodiment, the first crosslinked polymer has a different stiffness at low or high strain rates compared to the second polymer. In one embodiment, the first and second polymers have a difference in stiffness that may or may not depend on the rate of material deformation (strain rate). In another embodiment, the first crosslinked polymer has a stiffness at low or high strain rates different than that of the second polymer by at least 5% (percent difference). In another embodiment, the first crosslinked polymer has a stiffness at low or high strain rates different than that of the second polymer in a range of about 10% to about 500%, or about 50% to about 400%, or about 100% to about 300% (percent difference). In one embodiment, for example, the first cross-linked polymer and the second polymer have a difference in stiffness at low or high strain rates of over 2,000 MPa, or over 1,000 MPa, or over 500 MPa, or over 100 MPa, or over 10 MPa.

In a further embodiment, the first crosslinked polymer is an elastomeric polymer. In one embodiment, the elastomeric polymer is a polyurethane, polysiloxane (silicone), poly(meth)acrylate, polyether, polyamide, polyester, polythiol, or a combination thereof. In another embodiment, the elastomeric polymer is an elastomeric polyurethane. In one embodiment, the polyurethane is a urethane-based acrylate elastomer or an aromatic urethane-based acrylate elastomer. In a further embodiment, the urethane-based acrylate elastomer or aromatic urethane-based acrylate elastomer is formed from Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, CN9782.

In another embodiment of the disclosure, the crosslinker is a di-, tri-, tetra-, or multifunctional (meth)acrylate, a crosslinker having vinyl moieties, a crosslinker having thiol moieties, a crosslinker having epoxy moieties, a crosslinker having amine moieties, a crosslinker having alcohol moieties, or a crosslinker having carboxylic acid moieties. In a further embodiment, the crosslinker is Ebecryl 8413, CN9021, CN973J75, Formlabs Flexible 80A, Ebecryl 231, Ebecryl 4491, Ebecryl 242, Ebecryl 270, Ebecryl 1271, Ebecryl 8411, Ebecryl 8413, Ebecryl 4827, CN9031, CN966J75, or CN9782.

In another embodiment of the disclosure, the urethane-based acrylate elastomer or aromatic urethane-based acrylate elastomer contains a reactive diluent comprising Ebecryl 113, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, pentaerythritol tetraacrylate.

In one embodiment, the elastomeric polymer is a liquid crystal elastomer. In a further embodiment, the liquid crystal elastomer is formed from a precursor material comprising a liquid crystal mesogen and a chain extender. In one embodiment, the liquid crystal mesogen is a diacrylate and the chain extender is a dithiol and/or amine. In a further embodiment, the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; or 4-[3-[(1-oxo-2-propen-1-yl)oxy]propoxy]-1,1′-(1,4-phenylene) ester benzoic acid.

In another embodiment of the disclosure, the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

In another embodiment of the disclosure, the second polymer precursors are monomers of the second polymer. In one embodiment, the second polymer is a poly(meth)acrylate, polyurethane, polysiloxane (silicone), polyether, polyamide, polyester, polythiol, copolymers thereof or combinations thereof. In one embodiment, the poly(meth)acrylate is formed from 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 1,6-hexanediol diacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylic acid, methacrylic acid, hexyl acrylate, hexyl methacrylate, trimethylolpropane triacrylate, or pentaerythritol tetraacrylate.

In another embodiment, the photoinitiator is ethyl (2,4,6-trimethylbenzoyl) phenylphosphinate, benzoyl peroxide, camphorquinone, diphenyl (2,4,6-trimethylbenzoyl)phosphine oxide, phenylbis(2,4,6-trimethylbenzoyl)phosphine oxide, 2-hydroxy-4′-(2-hydroxyethoxy)-2-methylpropiophenone. In another embodiment, the photoinitiator is present in the range of about 0.1 to about 5.0 wt % in the photoinitiator/monomer mixture.

In another embodiment, the poly(meth)acrylate is a crosslinked polymer.

In a further embodiment, the three-dimensional shape is an architected material, a lattice composed of beams or surface elements, or a foam.

In another embodiment, three-dimensional shape has a relative density of less than 50%.

In one embodiment, the material is for vibration damping, vibration isolation, acoustic damping, acoustic isolation, or impact attenuation.

In another embodiment, the material is an energy absorbing material.

In one embodiment, the concentration gradient interpenetrating polymer network is a continuous concentration gradient interpenetrating polymer network.

In one embodiment, the 3D-printable polymer is printable through volumetric 3D printing, vat polymerization 3D printing, material jetting 3D printing, powder bed fusion, or material extrusion 3D printing.

Although the disclosure has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present disclosure.

### EXAMPLES

The operation of the disclosure is illustrated by the following representative examples. As is apparent to those skilled in the art, many of the details of the examples may be changed while still practicing the disclosure described herein.

### Materials and Methods

### Example 1

First Crosslinked Polymer Precursor Mixture Preparation: The Ebecryl elastomer photoresin was prepared by combining 1 wt % (weight percent) ethyl (2,4,6-trimethylbenzoyl) phenylphosphinate (TPO-L, Oakwood Products, Inc.) as the photoinitiator, 45 wt % Ebecryl 8413 (Allnex) as the crosslinker monomer, and 45 wt % Ebecryl 113 (Allnex) and 9 wt % isobornyl acrylate (technical grade, contains 200 ppm monomethyl ether hydroquinone as inhibitor, Sigma-Alrich Canada Co.) as reactive diluent monomers (the monomer weight ratio was 5:5:1) (Table 1). The mixture was then combined using a planetary centrifugal mixer (THINKY ARE-310) for 10 min at 2000 rpm followed by 30 s at 2200 rpm. The first crosslinked polymer precursor mixture was stored in the fridge until use. Before using, it was brought to room temperature by mixing for 2 min at 2000 rpm followed by 30 s at 2200 rpm.

Second Polymer Precursor Preparation: The photoinitator, TPO-L (1 wt %) was combined with 99 wt % monomer (2-hydroxyethyl methacrylate (HEMA, contains ≤250 ppm monomethyl ether hydroquinone as inhibitor, 97%, Sigma-Alrich Canada Co.) or 1,6-hexanediol diacrylate (HDDA, 99% stab., Thermo Scientific)) (Table 1). The mixture was mixed using a planetary mixer for 2 min at 2000 rpm followed by 30 s at 2200 rpm. The mixture was stored in the fridge until use. Before being used, it was brought to room temperature using the same mixing conditions as for the first crosslinked polymer precursor mixture.

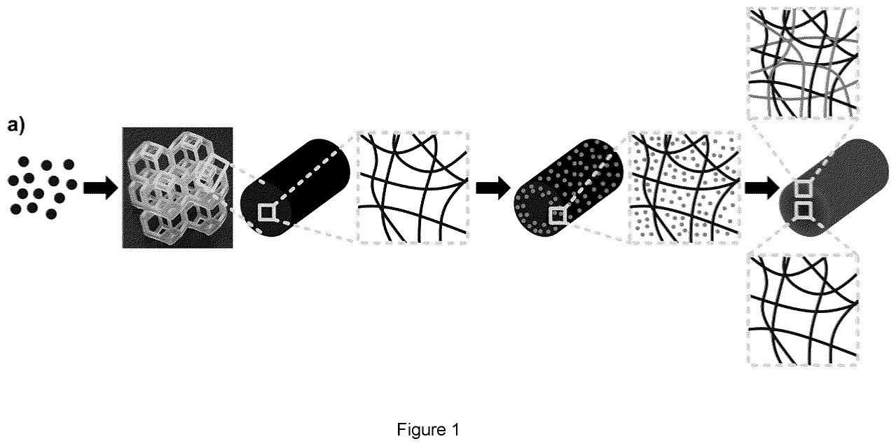

3D Printing of the First Crosslinked Polymer: An Asiga Max X UV385 Digital Light Processing (DLP) printer with a 385 nm LED light source was used for printing all lattices and rod samples. The samples were printed using a light intensity of 25 mW/cm², a slice thickness of 0.100 mm, exposure time of 1.938 s, burn-in (initial layers) exposure time of 15.684 s, 1 burn-in layer, and heater temperature set to 30° C. to warm the precursor mixture in the 1 L build tray. The printed objects were immersed in ethanol (95% vol., Commercial Alcohols by Greenfield Global) and sonicated for 10 min in order to remove residual uncured precursor material. The washing step was repeated twice more with new ethanol replenished in between. The washed samples were dried for 24 hours, then postcured with 1000 UV flashes in an Otoflash G171 UV light flash cure box (300 to 700 nm light) with nitrogen atmosphere purge. This 3D printing step is depicted in the first step in FIG. 1. For samples printed with HDDA and HEMA as the first crosslinked polymer, the washing step in ethanol was skipped and the samples were left to remove residual precursor material for 24 hours before curing with 1000 UV flashes.

Concentration Gradient Interpenetrating Polymer Network Formation (as depicted in FIG. 1): After printing and post-processing the 3D printed first crosslinked polymer (Ebecryl), the second polymer precursor was placed in a container, with enough volume to cover the 3D printed first crosslinked polymer lattice sample. The 3D printed first crosslinked polymer lattice was immersed in the second polymer precursor and placed on an orbital shaker (Thermo Scientific multi-purpose rotator) at speed 6 for the desired time. After the immersion time was complete, the sample was removed and excess precursor material was removed by dabbing with a paper towel, shaking the sample in paper towel, and dried with an air gun over all sides of the sample. The sample was then cured with a Formlabs Form Cure box (405 nm light) at constant temperature and time or with 1000 UV flashes with the Otoflash. As shown in FIG. 1, the lattices are 3D printed with the first crosslinked polymer followed by immersion in a second polymer precursor. The degree of diffusion of the second polymer precursor depends on the chemistry of the 3D printed first crosslinked polymer, the second polymer precursor, and the immersion time. The second polymer precursor is then cured in the 3D lattice. The struts within the final 3D printed lattice contain a concentration gradient interpenetrating polymer network.

### Example 2

Second Polymer with Fluorescent Dye Preparation: To observe the formation of a concentration gradient interpenetrating polymer network, a fluorescent dye was added to the second polymer precursor and allowed to diffuse into the first crosslinked polymer along with the second polymer precursor. The Fluorescent dye stock solution was first prepared by dissolving Fluorescein isothiocyanate isomer I (FITC, ≥90%, Sigma-Alrich Canada Co.) in anhydrous ethanol at a concentration of 15 mg/mL with 5 min of sonication (Cole-Parmer Ultrasonic Cleaner). Then 6.67 wt % of FITC stock solution was combined with 93.33 wt % of second polymer precursor using a vortex mixer (G560, Cole-Parmer Scientific Industries) for 1 min. The FITC-photoresin was wrapped with aluminum foil and stored in the fridge until use. Before being used, it was brought to room temperature.

Observation of Concentration Gradient Interpenetrating Polymer Network Formation and Fluorescence Imaging: The first crosslinked polymer (Ebecryl) was 3D printed and post-processed as described in Example 1 with the following dimensions: length 10 mm, width 4 mm, and thickness 1 mm. The same procedure as in Example 1 was used to form the concentration gradient interpenetrating polymer network, but with the second polymer and fluorescent dye mixture.

Fluorescent imaging samples were prepared by cutting each concentration gradient interpenetrating polymer network sample into 5 blocks. The fluorescence microscopy images were captured by scanning each cross-section of the block on an inverted microscope (IX81, Olympus Life Science) using a 4× object lens and FITC optical filter. With a 120 W fluorescence light source set to 100% output power, the exposure time was set as 300 ms for Ebecryl/FITC-HEMA IPN samples, and 900 ms for Ebecryl/FITC-HDDA IPN samples using InVitro microscope automation software. The thickness and the diffused depth of each cross-section were measured using ImageJ software to determine the diffusion ratio using the following equation:

$$Diffusion ratio = \frac{Diffusion depth ( μm )}{Cross - section thickness ( μ m )}$$

The diffusion ratios were averaged over ten measurements for each cross-section, four cross-sections for each sample, and two samples for each condition. As the boundary between the HDDA IPN outer phase and the Ebecryl inner phase was not as defined as HEMA IPN samples, the diffusion ratio was calculated only for HEMA IPN samples.

Cylindrical rods 12 mm in length, 1.25 mm in diameter were printed vertically on a base of 37.50×25.00×1.5 mm in order to test the formation of the concentration gradient interpenetrating polymer network by observing a change in mass and dimensions. Cylindrical rods with different diameters, 1.00, 1.25, 1.50, 1.75, and 2.00 mm, with a length of 24 mm were printed on a base of 37.50×25.00×1.5 mm for testing the effect of the size of the first crosslinked polymer on the formation of the concentration gradient interpenetrating polymer network. The mass before and after concentration gradient interpenetrating polymer network formation were compared to determine the wt % of the second polymer in the 3D printed samples using the following equation (2):

$$wt \% second polymer = \frac{mass of IPN - mass of crosslinked polymer}{mass of IPN} \qquad ( 2 )$$

The length and diameter of the cylindrical rods were compared before and after concentration gradient interpenetrating polymer network formation to determine the change in dimensions and were calculated using the following equation (3):

$$Length or Diameter Percent Change = \frac{\begin{matrix}length or diameter of IPN - \\ length or diameter of first crosslinked polymer\end{matrix}}{length or diameter of first crosslinked polymer} \qquad ( 3 )$$

The cylindrical rods for immersion tests were averaged over three rod samples.

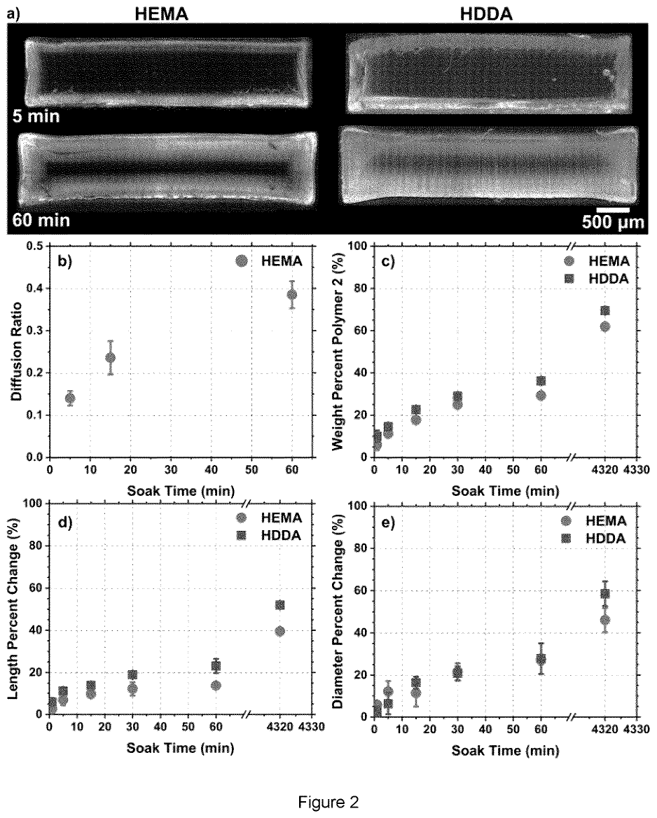

Both HE MA and HDDA IPN samples showed a clear Ebecryl inner phase and outer phase containing the second polymer and FITC dye for 5 min, 15 min, and 60 min of immersion time (FIG. 1 a, b, and FIG. 2). After 2 days of immersion time, the second polymer precursor with FITC dye fully diffused into the Ebecryl first crosslinked polymer. The increasing diffusion time of second polymer precursor also leads to the dimensional increase of the samples. Hence, diffusion ratio is calculated to exclude the effect of sample expansion. The diffusion ratio of HEMA IPN samples increases with increasing immersion time, indicating the thicker IPN outer phase being formed with longer immersion times. A similar trend is observed with HDDA IPN samples.

With the cylindrical rods, the amount of HEMA in the rods increases with increasing immersion time, the rate of which decreases overtime, indicating there is likely a maximum point of infusion of HEMA into the elastomeric first crosslinked polymer (Ebecryl) (FIG. 1 c, d, e). The formation of the HEMA IPN coincides with the expansion of the rod dimensions, both length and diameter. These results coincide with the thicker IPN outer phase being formed with longer immersion times, as seen in the fluorescence microscopy images. Similar trends are also observed with HDDA in the IPN, albeit with slightly higher weight percent and percent change in dimensions due to the faster diffusion of HDDA into the Ebecryl first crosslinked polymer compared to HEMA. Overall, 6.02±2.56 wt % (weight percent) HEMA and 9.94±2.85 wt % HDDA can be achieved in as little as 1 min soaking with highs of 61.93±0.11 wt % HEMA and 69.49±0.30 wt % HDDA observed with 3 days (4320 min) of soaking.

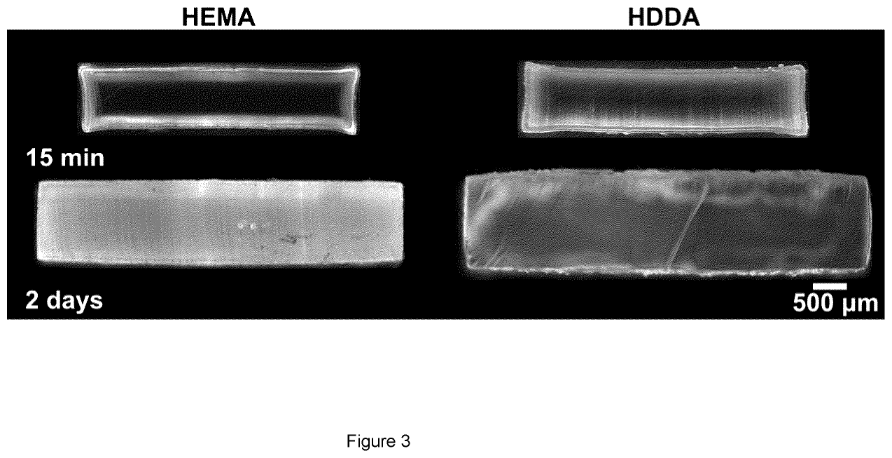

Similar tests were also performed on 24 mm long cylindrical rods with different diameters (1.00, 1.25, 1.50, 1.75, and 2.00 mm) and a constant immersion time of 15 min in HEMA and HDDA (FIG. 3). These tests revealed that the amount of HEMA and HDDA incorporated into the rods decreases with increasing rod diameter. While the second polymer precursor diffusion rate and overall thickness of the IPN outer phase remains the same between samples, thicker rods result in a smaller outer phase to inner phase ratio and overall lower weight percent second polymer in the concentration gradient IPN.

### Example 3

Copolymer Precursor Material Preparation: To determine if the change in mechanical properties is due to the concentration gradient interpenetrating polymer network or the introduction of the second polymer precursor materials into the 3D structure, a “copolymer” of the first crosslinked polymer and second polymer was 3D printed. The copolymer consisted of a mixture of the first crosslinked polymer and second polymer in the same weight ratio as formed with the concentration gradient interpenetrating polymer network (Table 1). Premixed first crosslinked polymer and second polymer precursor materials were combined in the same weight ratio and mixed using a planetary mixer for 10 min at 2000 rpm followed by 30 s at 2200 rpm. For example, if the equivalent concentration gradient interpenetrating polymer network was 15 wt % HEMA, then 15 wt % HEMA second polymer precursor material was combined with 85 wt % Ebecryl first crosslinked polymer precursor material to create the copolymer precursor material. Similar to Example 1, the copolymer precursor material was stored in the fridge and warmed using the planetary mixer before being used, followed by 3D printing. For the Ebecryl+HEMA copolymer, the exposure time was instead set to 10.000 s with 2 burn-in layers. Rectangular rods of 12×2×0.5 mm in dimensions were printed vertically for tensile test measurements (Diastron Fibre Micrometer).

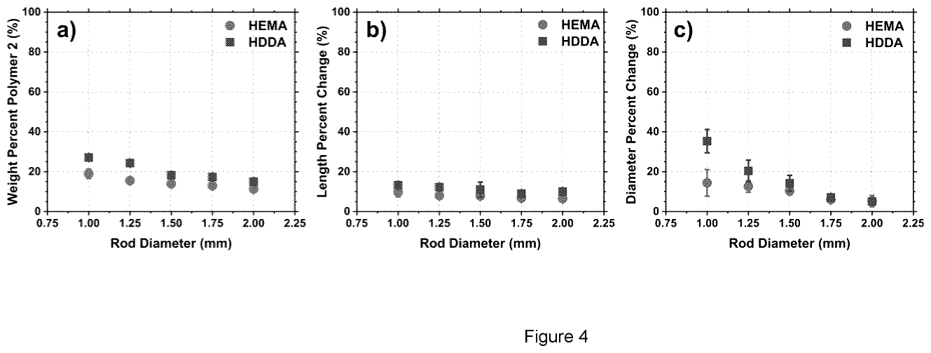

Preliminary tensile tests on rectangular struts (FIG. 4) show a wide range of mechanical properties achievable by varying the type of second polymer used for forming the IPN. Behavior ranges from the elastomeric first crosslinked polymer, to a very rigid, strong and brittle IPN when long immersion times with the crosslinker, 1,6-hexanediol diacrylate (HDDA) are used. Using linear polymers in the IPN, such as those made from 2-hydroxyethyl methacrylate (HEMA), unlocks highly important intermediate performance spaces. Most notably, we observe IPNs that benefit in strength and elastic modulus (peak stress and slope of curves), yet conserve much of the ductility and elongation enabled by the soft first crosslinked polymer. This leads to an excellent balance between strength and toughness (energy absorption, area under the curve). The intermediate IPN behavior is also characterized by strain hardening, or increasing slope during yielding, which indicates a self-strengthening mechanism likely imparted by the covalently intertwined interface. A homogenous mixture of the first crosslinked polymer and second polymer (copolymer, no outer and inner phases or IPN), printed together from the start displays different mechanical properties compared to those with a concentration gradient IPN (lower toughness and strength), illustrating the benefit of the concentration gradient IPN.

### Example 4

Compression Tests of 3D Printed Lattices: Lattices comprising of the concentration gradient interpenetrating polymer network and copolymers were fabricated to evaluate the energy absorption properties. Kelvin and Octet lattices were tested with 2×2×2 unit cells and computer aided design (CAD) files with dimensions of 24.99×24.99×24.99 mm, and strut sizes of 1.25 mm. The relative densities of the Kelvin and octet lattices were 0.07 and 0.14, respectively.

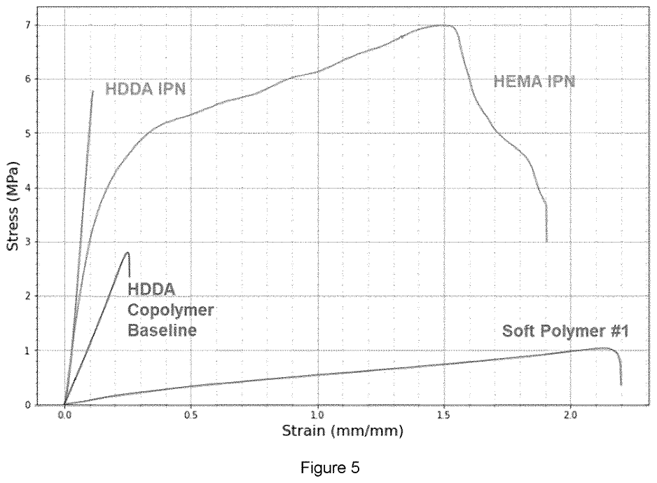

As with the individual struts, here too the concentration gradient IPN has a significant effect on the lattice material's mechanical properties. First, the stress-strain curve and mechanical properties were observed with different immersion times (FIG. 5, Table 2). Kelvin lattices composed of elastomeric Ebecryl first crosslinked polymer were immersed in HEMA for 5, 15, 30, and 60 min and had increasing toughness at densification with increasing soaking times with an over 300-fold increase in toughness with the thickest IPN shell (60 min immersion time) compared to the elastomeric first crosslinked polymer. The thicker HEMA concentration gradient IPN outer phase with increasing immersion times stiffens the material and allows forfaster energy dissipation. The higher energy absorption is due to the higher initial peak stress and stiffness, resulting in more ideal energy dissipation. Below 30 min of soaking in HEMA produces a flatter stress-strain curve with the ability to maintain the force under further compression, which is ideal for energy absorbers. The HEMA Kelvin lattices also fully reformed after compression tests, exhibiting ideal properties for multi-hit energy absorbing materials. Similar results were also observed when the elastomeric first crosslinked polymer was replaced with a commercial elastomeric, Formlabs Flexible 80A.

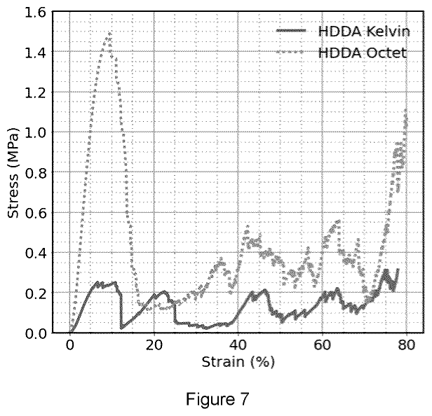

Octet lattices were also fabricated with an HDDA concentration gradient IPN and found to have the highest toughness as a result of both the stretching-dominated octet lattice geometry, higher relative density of the lattice, and the highly crosslinked, stiffer HDDA second polymer. Again, increased immersion time raised the energy absorption by over 180-times greater than the same lattice composed of only the elastomeric first polymer. However, with increasing amounts of HDDA and a larger HDDA concentration gradient IPN outer phase, larger drops in load bearing capacity were observed, particularly with 60 min of immersion time in HDDA. This is a result of the octet lattice geometry. As a comparison, an octet lattice with HDDA as the first crosslinked polymer was printed (FIG. 7). While it had the highest toughness, it is not very efficient at absorbing energy (maximum efficiency of 22.55±1.78%) with catastrophic drops in load bearing capacities due to the complete fracturing of the brittle lattice struts. We were unable to 3D print lattices with HEMA as the first crosslinked polymer due to the linear polymer and lack of crosslinking to support layer-by-layer fabrication. Overall, the characteristics of the IPN lattices can easily be tuned for a multitude of applications by altering both the amount of second polymer incorporated into the IPN and the geometry of the lattice.

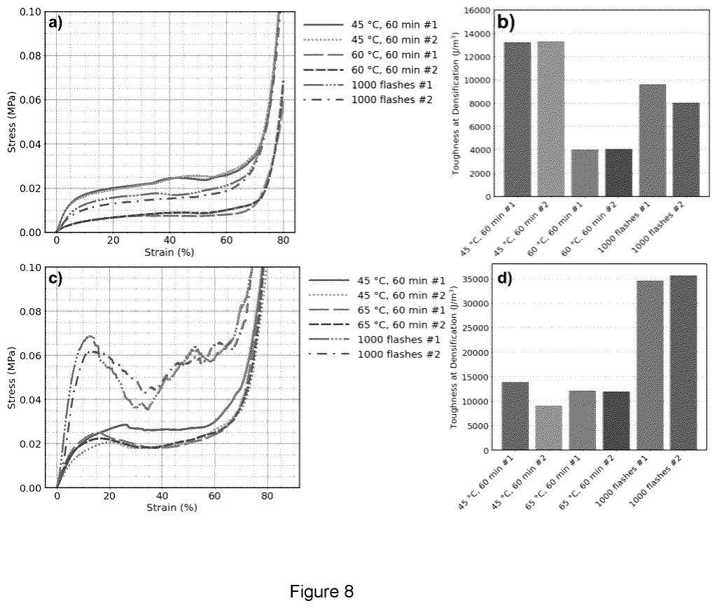

Curing conditions of HEMA and HDDA as the second polymer were also shown to have an effect on mechanical properties and the shape of the stress-strain curve due to the control of the extent of polymerization and modulus with light intensity. This was demonstrated with variations in mechanical properties from compression tests with curing HDDA and HEMA second polymer under flashes of UV light or constant curing of 405 nm light at a fixed temperature (FIG. 8, Table 3). Different curing conditions of HEMA as the second polymer lead to stress-strain curves with similar “flat” shapes but different mechanical properties. For example, constant exposure of HEMA concentration gradient IPN samples to 405 nm light at 45° C. for 60 min showed a toughness at densification of 13.28±0.03 kJ/m³, surpassing the toughness of the samples with 1000 flashes of UV light (8.86±1.11 kJ/m³) and the samples cured at 60° C. for 60 min (4.09±0.03 kJ/m³). Similar improvements of other mechanical properties, such as maximum energy absorption efficiency and stiffness, were observed in samples treated with constant curing at 45° C. for 60 min. Furthermore, constant curing leads to mechanical properties with less variation compared with flash curing since constant curing has better control over temperature. For example, a toughness at densification of 35.13±0.76 kJ/m³ was achieved by curing HDDA with 1000 flashes of UV light compared to 12.05±0.11 kJ/m³ by curing HDDA at a constant exposure to 405 nm light at 65° C. for 60 min. Polymerizing the second polymer with the more intense 1000 flashes of UV light lead to a greater extent of polymerization and higher crosslink density for HDDA. With the higher extent of polymerization via 1000 flashes of UV light, a different shape of the stress-strain curve was observed with a high peak stress dropping down with the collapse of struts compared to the more ideal “flat” curve with constant curing. Constant curing conditions for 60 min at 45° C. for HEMA and 65° C. for HDDA second polymers were predominantly used as the lattices had more uniform curing (visually observed both before and during compression tests) and mechanical properties from compression tests were more consistent between repeat samples. But light intensity and extent of polymerization provides another handle to tune mechanical properties and energy absorption of IPN lattices.

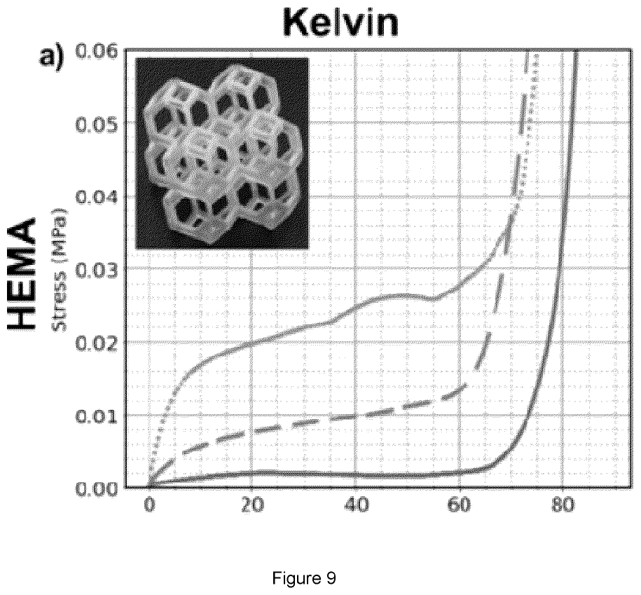

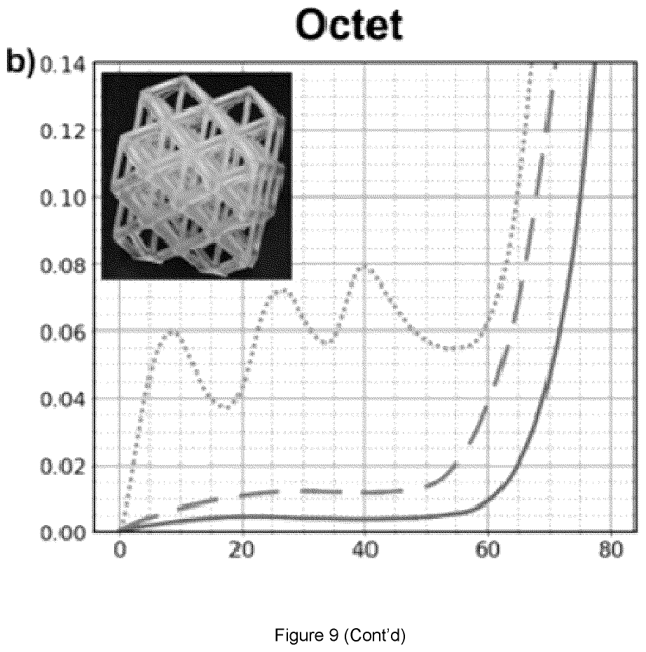

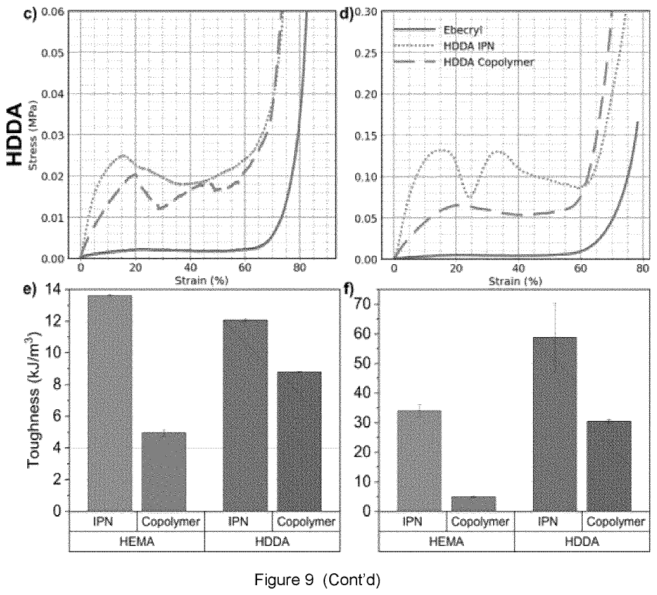

Much like for the tensile tests, Kelvin and octet lattices (FIGS. 9a and b inset pictures) were fabricated with copolymers of Ebecryl and HEMA or HDDA to confirm the improved energy absorption properties were a result of the concentration gradient IPN and not the incorporation of HEMA or HDDA in the polymer material (FIG. 9, Table 4). All four IPN lattices, Kelvin and octet with HEMA and HDDA as the second polymer, surpassed the toughness of the corresponding copolymer lattices. In particular, the octet HEMA concentration gradient IPN lattice had a toughness at densification of 33.94±2.16 kJ/m³ compared to 4.92±0.32 kJ/m³ for the octet HEMA copolymer, both with similar wt % HEMA in the material. Additionally, all four concentration gradient IPN lattices have higher maximum efficiencies and stiffness compared to the equivalent copolymers, demonstrating their superior performance as energy absorbers. The toughness of the HEMA octet lattices compared to that of Kelvin lattices drastically increases by almost 2.5 times for the concentration gradient IPN, but not for the copolymer (similar at ~4.9 kJ/m³). As well, there is a major change in the shape of the stress-strain curve with more typical stress drops in the HEMA concentration gradient IPN octet lattice. This is due to the stiffer concentration gradient IPN struts exhibiting more drastic buckling, corresponding to each half of the two unit cells. As expected for stretching-dominated lattices with higher relative density, the toughness increases for both HDDA concentration gradient IPN and copolymer octet lattices compared to the respective Kelvin lattices. The toughness and stiffness are greater for the HDDA concentration gradient IPN octet lattice than the HEMA concentration gradient IPN octet lattice likely due to the ability for HDDA to crosslink and higher diffusivity of HDDA for the same 15 min immersion time (higher wt % HDDA than HEMA in lattices). The stiffer HDDA concentration gradient IPN seems to have less of an effect with the bending-dominated Kelvin lattice as the toughness is lower than that of the HEMA IPN Kelvin lattice. But this difference between HEMA and HDDA concentration gradient IPN lattices can be tuned with the extent of polymerization and crosslinking as seen previously with the higher energy absorption of HDDA concentration gradient IPNs cured with 1000 UV flashes. Again, lattices composed of HDDA as the first crosslinked polymer display poor energy absorption with both Kelvin and octet lattice geometries as significant fracturing occurs with catastrophic drops in load bearing capacity and destruction of the lattice (FIG. 7, Table 4). Overall, the first and second phase IPN structure leads to enhanced stiffening and dissipation of energy throughout the lattices and can be easily tuned for the desired application with type of second polymer, thickness of outer phase, and lattice geometry. The concentration gradient-IPN lattices show minimal to no failure due to the gradient in properties and less abrupt material interface that is able to distribute the stress.

### Example 5

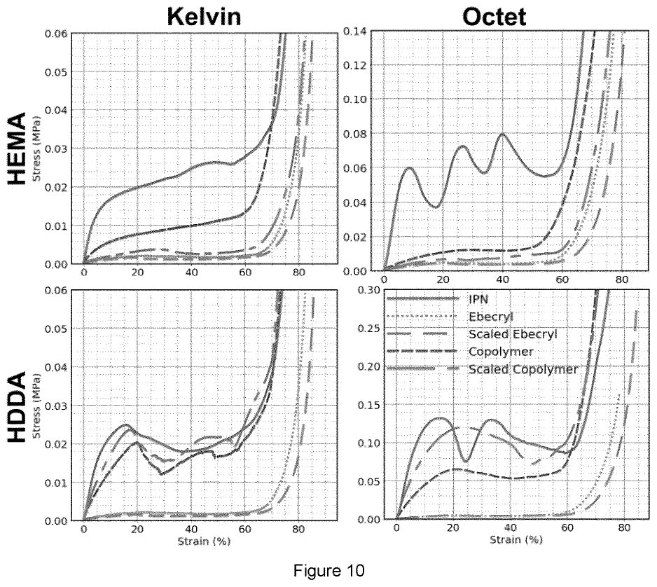

Scaling of First Crosslinked Polymer Lattices and Copolymer Lattice to the Same Size as the Concentration gradient IPN Lattices: It was observed that as more mass is added to the elastomer first crosslinked polymer lattice with the formation of the concentration gradient-IPN, the dimensions of the lattice increase. To support the findings that concentration gradient-IPN contributes to the enhanced energy absorption, Ebecryl and copolymer lattices were scaled and printed to be similar in size to the IPN lattices (FIG. 10, Table 5). The scaling factor was determined from the average percent difference in dimensions between the concentration gradient IPN and elastomeric or copolymer lattices, which was then applied to the CAD file before printing. The elastomeric and copolymer lattices printed with the scaled CAD file resulted in similar overall volume to the concentration gradient IPN lattices. The mechanical properties of the Ebecryl first crosslinked polymer lattices scaled to be similar size to the HDDA and HEMA concentration gradient IPN lattices were very similar to the original sized Ebecryl first crosslinked polymer lattices. For the scaled HEMA copolymer lattices, the toughness decreased compared to the original HEMA copolymer lattices, for both Kelvin and octet lattices, predominantly due to the lower stiffness. Because HEMA is a monofunctional monomer, it decreases the amount of crosslinking in the copolymer compared to the Ebecryl monomers, contributing to a lower stiffness material. The effect of the lower stiffness polymer becomes more obvious under compression with the bending or stretching of longer struts of the scaled lattice. The opposite was true for the HDDA copolymer lattices where toughness and stiffness increased compared to the original sized copolymer lattices and the difunctional HDDA monomer creating a stiffer material. Overall, the original conclusion remained where the IPN lattices had higher toughness, due to higher stiffness, than the copolymers with equivalent wt % second polymer, for both the original sized and scaled copolymer lattices. For example, the largest difference of over 30 kJ/m³ occurred between the HEMA concentration gradient IPN and scaled HEMA copolymer octet lattices (33.94±2.16 vs. 3.55±0.18 kJ/m³, respectively). The scaled HDDA copolymer octet lattice had similar toughness to the HDDA concentration gradient IPN octet lattice, but could be tuned with degree of cure of the HDDA second polymer in the IPN outer phase.

### Example 6

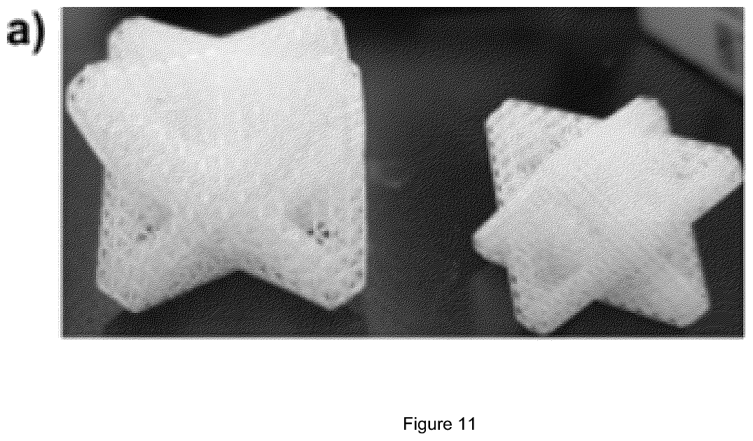

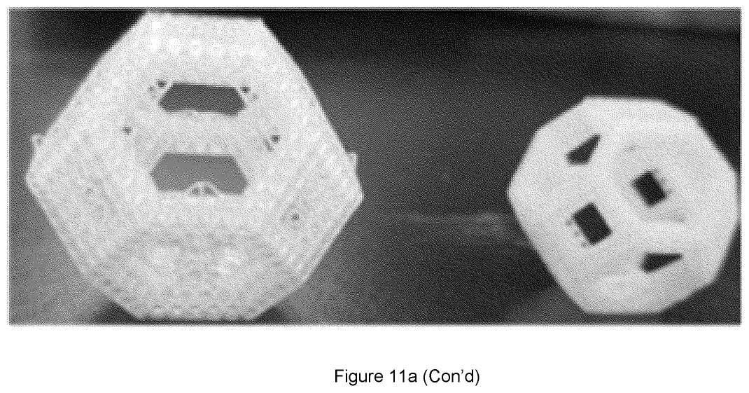

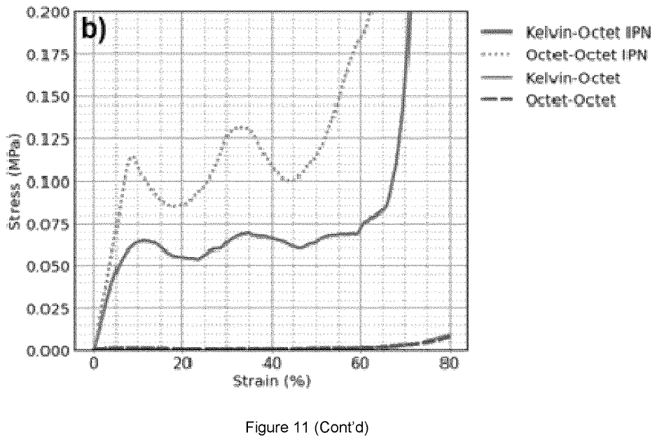

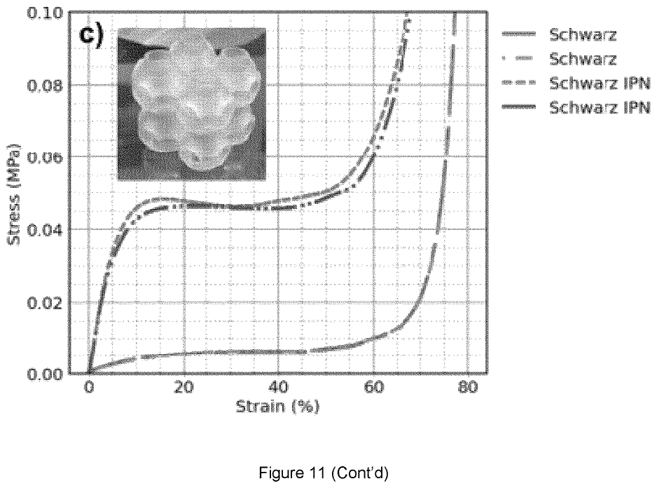

Concentration gradient IPN Lattices with Hierarchical and Other Lattice Geometries: Multi-scale hierarchical lattice designs can be thought of lattices within the struts of another larger lattice (FIG. 11a, Table 6). It was theorized that extending the deformation modes with two hierarchical stages of elastic collapse would further improve energy absorption properties. For example, multi-scale lattices with a first order Octet lattice and second order Kelvin or Octet lattice were printed and tested with Formlabs Flexible 80A first crosslinked polymer with and without concentration gradient IPN (FIG. 11a, b). While little-to-no improvement in toughness at densification was observed for the multi-scale hierarchical lattices composed of just the Formlabs Flexible 80A first crosslinked polymer compared to non-hierarchical lattices, immersion in HEMA second polymer for 15 min resulted in significant increase in energy absorption. This is due to the small strut thicknesses and significant increase in weight percent of the HEMA second polymer in the concentration gradient IPN. In addition, the stress-strain curves show a steep initial stiffness, albeit with a variable plateau stress compared to the first crosslinked polymer lattices. Performance can be tuned by decreasing the immersion time and thickness of the concentration gradient IPN outer phase in the lattice struts.

As well, other types of unit cells were tested to observe the effect on toughness with and without HEMA concentration gradient IPN. A triply periodic minimal surface (TPMS) geometry called the Schwarz surface was tested and compared to the Kelvin and octet lattices. While the toughness at densification is lower than the Kelvin and octet lattices, the initial stiffness is remarkably steep, followed by an impressively flat part of the curve, indicating its ability to maintain strength under further compression (FIG. 11c). The lower energy absorption could also be attributed to the lower weight percent of HEMA second polymer in the concentration gradient IPN at 18.64±0.54% compared to the other concentration gradient IPN lattices tested. The wall thickness of the Schwarz surface is larger than the strut sizes, requiring longer immersion times to achieve the same weight percent concentration gradient IPN. In addition, the IPN Schwarz structures fully recovered after the compression tests.

### Example 7

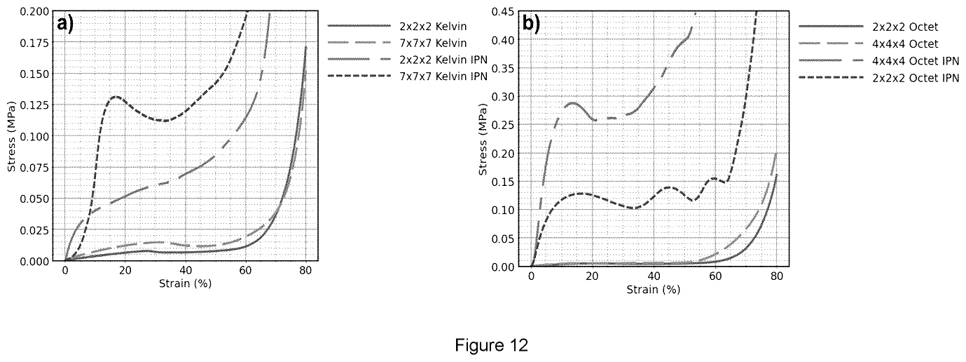

Effect of Number of Unit Cells on Concentration gradient IPN Lattices: Lattices up to this point had designs of 2×2×2 unit cells with dimensions of 25.18×25.18×24.99 mm. Increasing the number of unit cells within the same dimensions extends the modes of deformation, allowing the ability to tune energy absorption while keeping the size constant. Therefore, Kelvin and Octet lattices were printed with unit cells of 2×2×2 and 7×7×7 (Kelvin) or 4×4×4 (Octet) while keeping the relative density constant at 0.15 and overall dimensions of 25.18×25.18×25.00 mm. A second set of lattices was also immersed in HEMA second polymer to create concentration gradient IPN lattices in order to further optimize the energy absorption (FIG. 12, Table 7).

Comparing the compression tests on the lattices with the first crosslinked polymer, the urethane-based Ebecryl, the 2×2×2 and 7×7×7 Kelvin lattices had similar shapes, but the 7×7×7 lattices had overall higher toughness at densification (FIG. 12, Table 7). For the IPN lattices, the highest energy absorption is achieved with a higher number of unit cells. While the toughness at densification does increase from the 2×2×2 first crosslinked polymer lattices to the 2×2×2 concentration gradient IPN lattices, a much larger increase is achieved with the 7×7×7 concentration gradient IPN lattices (around 10 times increase from 7×7×7 first crosslinked polymer lattice to 7×7×7 concentration gradient IPN lattice). The octet 2×2×2 and 4×4×4 lattices composed of the first crosslinked polymer (Ebecryl) have comparable shapes and toughness at densification. However, energy absorption significantly increases with the IPN lattices, similar to the Kelvin lattices. Because of the thinner struts of the 4×4×4 lattices, a larger amount of HEMA second polymer precursor material diffused into the first crosslinked polymer, causing a thicker concentration gradient IPN outer phase within the struts, and significantly increasing the toughness. Overall, tuning of the toughness, stiffness, and maximum efficiency can be achieved with a concentration gradient IPN, lattice type, and number of unit cells per area.

### Example 8

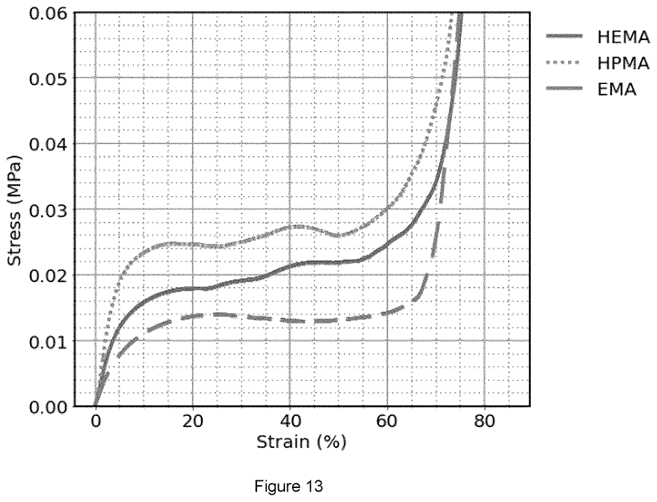

Effect of Second Polymer on Concentration gradient IPN Lattices: Other second polymers were also studied to determine the effect of the type of concentration gradient IPN on the compression mechanical properties. In addition to HEMA and HDDA second polymers, hydroxypropyl methacrylate (HPMA) and ethyl methacrylate (EMA) were also tested, with EMA not containing a hydroxyl group that can contribute to hydrogen bonding. The HEMA, HPMA, and EMA concentration gradient IPN lattices contained similar wt % second polymer (~14 wt %), but exhibited different mechanical properties (FIG. 13, Table 8). The HPMA concentration gradient IPN lattices had the highest stiffness and toughness, while the EMA concentration gradient IPN lattices had the lowest, with HEMA concentration gradient IPN in between. It is theorized that hydrogen bonding between the first crosslinked polymer and second polymer contributes to a tougher concentration gradient IPN outer phase. Therefore, energy absorption can be tuned with the type of second polymer and hydrogen bonding crosslinking.

### Example 9

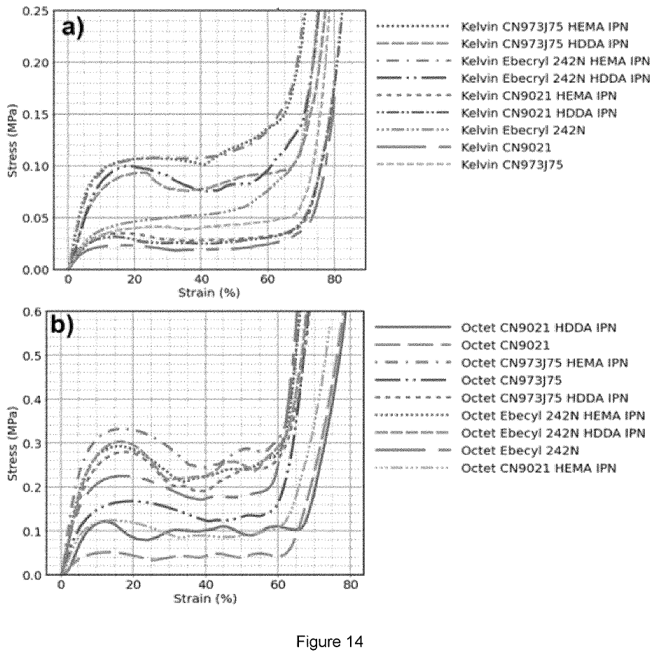

Effect of Stiffer First Crosslinked Polymer on Concentration gradient IPN Lattices: The soft urethane-based Ebecryl elastomer first crosslinked polymer was replaced with a series of other stiffer urethane-based polymers to determine the ability to create a concentration gradient IPN lattice and alter energy absorption. 3D printed Kelvin and octet lattices were 3D printed with commercial first crosslinked polymer precursor materials CN973J75, Ebecryl 242N, or CN9021, diluted with an appropriate amount of isobornyl acrylate as a reactive diluent to decrease the viscosity to enable 3D printing (Table 1). This was followed by immersion in HDDA or HEMA for 15 min to create the concentration gradient IPN. As found previously with the Ebecryl first crosslinked polymer, the concentration gradient IPN increases stiffness and toughness with all first crosslinked polymers tested (FIG. 14, Table 9). The HDDA second polymer precursor material also diffused more into the first crosslinked polymers more quickly than HEMA polymer second precursor material (higher wt % second polymer), but it varied whether the HDDA or HEMA concentration gradient IPN lattices had the highest toughness and energy absorption. Overall, these results show that the concentration gradient IPN can improve energy absorption properties with stiffer first crosslinked polymers.

While the present disclosure has been described with reference to what are presently considered to be the preferred examples, it is to be understood that the application is not limited to the examples described herein. To the contrary, the present disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

TABLE 1
First Crosslinked Polymer and Second Polymer Precursor Material Mixtures.

| | | | | |
|---|---|---|---|---|
| ID # - | | Chemical (Abbreviation) | | Weight |
| Name | Polymer Type | [Company] | Type of Material | Ratio |

First Crosslinked Polymer Precursor Materials

| | | | | |
|---|---|---|---|---|
| 1 - | Urethane-based | ethyl (2 4 6-trimethylbenzoyl) | Photoinitiator | 1 |
| Ebecryl | acrylate | phenylphosphinate (TPO-L) | | |
| (Eb.) | elastomer | [Oakwood Chemical] | | |
| | | Ebecryl 8413 [Allnex] | Crosslinker | 45 |
| | | | (diacrylate) | |
| | | Ebecryl 113 [Allnex] | Monomer (acrylate) | 45 |
| | | isobornyl acrylate (IBA) [Sigma | Monomer (acrylate) | 9 |
| | | Aldrich] | | |
| 2 - | Elastomer | Formlabs Flexible 80A [Formlabs] | Mixture of | 100 |
| F80A | | | photoinitiator(s), | |
| | | | monomer(s), | |
| | | | crosslinker(s) | |
| 3 - | Urethane-based | ethyl (2 4 6-trimethylbenzoyl) | photoinitiator | 1 |
| Ebecryl | acrylate | phenylphosphinate (TPO-L) | | |
| 242N | elastomer | [Oakwood Chemical] | | |
| | | Ebecryl 242N [Allnex] | Crosslinker | 84 |
| | | | (diacrylate) | |
| | | isobornyl acrylate (IBA) [Sigma | Monomer (acrylate) | 15 |
| | | Aldrich] | | |
| 4 - | Urethane-based | ethyl (2 4 6-trimethylbenzoyl) | Photoinitiator | 1 |
| CN9021 | acrylate | phenylphosphinate (TPO-L) | | |
| | elastomer | [Oakwood Chemical] | | |
| | | CN9021 [Sartomer] | Crosslinker | 69 |
| | | | (diacrylate) | |
| | | isobornyl acrylate (IBA) [Sigma | Monomer (acrylate) | 30 |
| | | Aldrich] | | |
| 5 - | Aromatic | ethyl (2 4 6-trimethylbenzoyl) | Photoinitiator | 1 |
| CN973J75 | urethane-based | phenylphosphinate (TPO-L) | | |
| | acrylate | [Oakwood Chemical] | | |
| | elastomer | CN973J75 [Sartomer] | Crosslinker | 74 |
| | | | (diacrylate) | |
| | | isobornyl acrylate (IBA) [Sigma | Monomer (acrylate) | 25 |
| | | Aldrich] | | |
| 6 - | Liquid crystal | 1,4-Bis-[4-(3- | Mesogen/liquid crystal | 42.18 |
| LCE | elastomer | acryloyloxypropyloxy)benzoyloxy]- | monomer/crosslinker | |
| | | 2-methylbenzene (RM257) | (diacrylate) | |
| | | [Wilshire Technologies] | | |
| | | toluene | Solvent | 42.18 |
| | | 2,2′(ethylenedioxy) diethanethiol | Monomer (dithiol) | 12.51 |
| | | (EDDET) [Sigma Aldrich] | | |
| | | ethyl (2 4 6-trimethylbenzoyl) | Photoinitiator | 0.27 |
| | | phenylphosphinate (TPO-L) | | |
| | | [Oakwood Chemical] | | |
| | | triethylamine (TEA) [Sigma | Catalyst | 2.73 |
| | | Aldrich] | | |
| | | Pyrogallol [Sigma Aldrich] | Inhibitor | 0.11 |
| | | Sudan I | Photoabsorptive dye | 0.01 |
| 7 - | Copolymer | ethyl (2 4 6-trimethylbenzoyl) | Photoinitiator | 85 |
| HEMA | baseline | phenylphosphinate (TPO-L) | | |
| Copolymer | material | [Oakwood Chemical] | | |
| | | Ebecryl 8413 [Allnex] | Crosslinker | |
| | | | (diacrylate) | |
| | | Ebecryl 113 [Allnex] | Monomer (acrylate) | |
| | | isobornyl acrylate (IBA) [Sigma | Monomer (acrylate) | |
| | | Aldrich] | | |
| | | ethyl (2 4 6-trimethylbenzoyl) | Photoinitiator | 15 |
| | | phenylphosphinate (TPO-L) | | |
| | | [Oakwood Chemical] | | |
| | | 2-hydroxyethyl methacrylate | Monomer (acrylate) | |
| | | (HEMA) [Sigma Aldrich] | | |
| 8 - | Copolymer | ethyl (2 4 6-trimethylbenzoyl) | Photoinitiator | 79 |
| HDDA | baseline | phenylphosphinate (TPO-L) | | |
| Copolymer | material | [Oakwood Chemical] | | |
| | | Ebecryl 8413 [Allnex] | Crosslinker | |
| | | | (diacrylate) | |
| | | Ebecryl 113 [ Allnex] | Monomer (acrylate) | |
| | | isobornyl acrylate (IBA) [Sigma | Monomer (acrylate) | |
| | | Aldrich] | | |
| | | ethyl (2 4 6-trimethylbenzoyl) | Photoinitiator | 21 |
| | | phenylphosphinate (TPO-L) | | |
| | | [Oakwood Chemical] | | |
| | | 1,6-hexanediol diacrylate (HDDA) | Crosslinker | |
| | | [Alfa Aesar] | (diacrylate) | |

Second Polymer Precursor Material

| | | | | |
|---|---|---|---|---|
| 1 - | Crosslinked | ethyl (2 4 6-trimethylbenzoyl) | Photoinitiator | 1 |
| HDDA | acrylate | phenylphosphinate (TPO-L) | | |
| | | [Oakwood Chemical] | | |
| | | 1,6-hexanediol diacrylate (HDDA) | Crosslinker | 99 |
| | | [Alfa Aesar] | (diacrylate) | |
| 2 - | Linear | ethyl (2 4 6-trimethylbenzoyl) | Photoinitiator | 1 |
| HEMA | acrylate | phenylphosphinate (TPO-L) | | |
| | | [Oakwood Chemical] | | |
| | | 2-hydroxyethyl methacrylate | Monomer (acrylate) | 99 |
| | | (HEMA) [Sigma Aldrich] | | |
| 3 - | Linear | ethyl (2 4 6-trimethylbenzoyl) | Photoinitiator | 1 |
| EMA | acrylate | phenylphosphinate (TPO-L) | | |
| | | [Oakwood Chemical] | | |
| | | ethyl methacrylate (EMA) [Sigma | Monomer (acrylate) | 99 |
| | | Aldrich] | | |
| 4 - | Linear | ethyl (2 4 6-trimethylbenzoyl) | Photoinitiator | 1 |
| HPMA | acrylate | phenylphosphinate (TPO-L) | | |
| | | [Oakwood Chemical] | | |
| | | hydroxypropyl methacrylate | Monomer (acrylate) | 99 |
| | | (HPMA) [Sigma Aldrich] | | |

TABLE 2
Mechanical Properties from Compression Tests of 3D Printed IPN Lattices with Different
Immersion Times in the Second Polymer Precursor Materials (see FIG. 5).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| Elastomer | Ebecryl/— | — | — | Octet | 2 × 2 × 2 | 0.14 | 1.65 ± 0.16 | 42.72 ± 2.95 | 22.02 ± 0.08 |
| Brittle | HDDA/— | — | — | Octet | 2 × 2 × 2 | 0.14 | 343.97 ± 14.52 | 22.55 ± 1.78 | 16968.33 ± 1829.25 |
| polymer | | | | | | | | | |
| IPN | Ebecryl/HDDA | 1000 flashes | 20.45 ± 0.79 | Octet | 2 × 2 × 2 | 0.14 | 90.87 ± 9.43 | 45.60 ± 1.82 | 1489.84 ± 351.84 |
| IPN | Ebecryl/HDDA | 1000 flashes | 26.53 ± 1.09 | Octet | 2 × 2 × 2 | 0.14 | 162.02 ± 6.32 | 46.90 ± 5.20 | 2807.49 ± 262.00 |
| IPN | Ebecryl/HDDA | 1000 flashes | 28.16 ± 0.08 | Octet | 2 × 2 × 2 | 0.14 | 207.71 ± 15.68 | 45.96 ± 1.22 | 3775.24 ± 262.56 |
| IPN | Ebecryl/HDDA | 1000 flashes | 36.15 ± 0.66 | Octet | 2 × 2 × 2 | 0.14 | 304.78 ± 61.56 | 40.18 ± 5.11 | 7668.07 ± 282.34 |
| Elastomer | Ebecryl/— | — | — | Kelvin | 2 × 2 × 2 | 0.07 | 0.56 ± 0.00 | 42.98 ± 0.19 | 9.31 ± 0.06 |
| IPN | Ebecryl/HEMA | 1000 flashes | 14.33 ± 0.59 | Kelvin | 2 × 2 × 2 | 0.07 | 7.87 ± 4.36 | 47.97 ± 0.44 | 75.01 ± 39.47 |
| IPN | Ebecryl/HEMA | 1000 flashes | 20.04 ± 0.12 | Kelvin | 2 × 2 × 2 | 0.07 | 15.64 ± 2.06 | 45.74 ± 2.24 | 148.40 ± 21.13 |
| IPN | Ebecryl/HEMA | 1000 flashes | 26.04 ± 1.23 | Kelvin | 2 × 2 × 2 | 0.07 | 22.78 ± 1.12 | 44.64 ± 6.31 | 203.22 ± 39.87 |
| IPN | Ebecryl/HEMA | 1000 flashes | 29.62 ± 1.09 | Kelvin | 2 × 2 × 2 | 0.07 | 31.38 ± 7.91 | 47.04 ± 0.47 | 291.08 ± 135.91 |
| Elastomer | Formlabs Flexible | — | — | Kelvin | 2 × 2 × 2 | 0.07 | 1.65 ± 0.04 | 30.04 ± 0.23 | 14.78 ± 0.54 |
| | 80A/— | | | | | | | | |
| IPN | Formlabs Flexible | 1000 flashes | 21.45 ± 0.54 | Kelvin | 2 × 2 × 2 | 0.07 | 22.67 ± 1.42 | 41.19 ± 0.65 | 155.49 ± 0.16 |
| | 80A/HEMA | | | | | | | | |
| IPN | Formlabs Flexible | 1000 flashes | 24.51 ± 0.39 | Kelvin | 2 × 2 × 2 | 0.07 | 23.40 ± 2.73 | 43.04 ± 2.62 | 183.30 ± 75.72 |
| | 80A/HEMA | | | | | | | | |
| IPN | Formlabs Flexible | 1000 flashes | 30.39 ± 0.69 | Kelvin | 2 × 2 × 2 | 0.07 | 28.77 ± 2.29 | 44.61 ± 2.54 | 262.62 ± 63.59 |
| | 80A/HEMA | | | | | | | | |
| IPN | Formlabs Flexible | 1000 flashes | 31.71 ± 0.08 | Kelvin | 2 × 2 × 2 | 0.07 | 46.79 ± 1.50 | 50.10 ± 0.31 | 350.72 ± 21.67 |
| | 80A/HEMA | | | | | | | | |

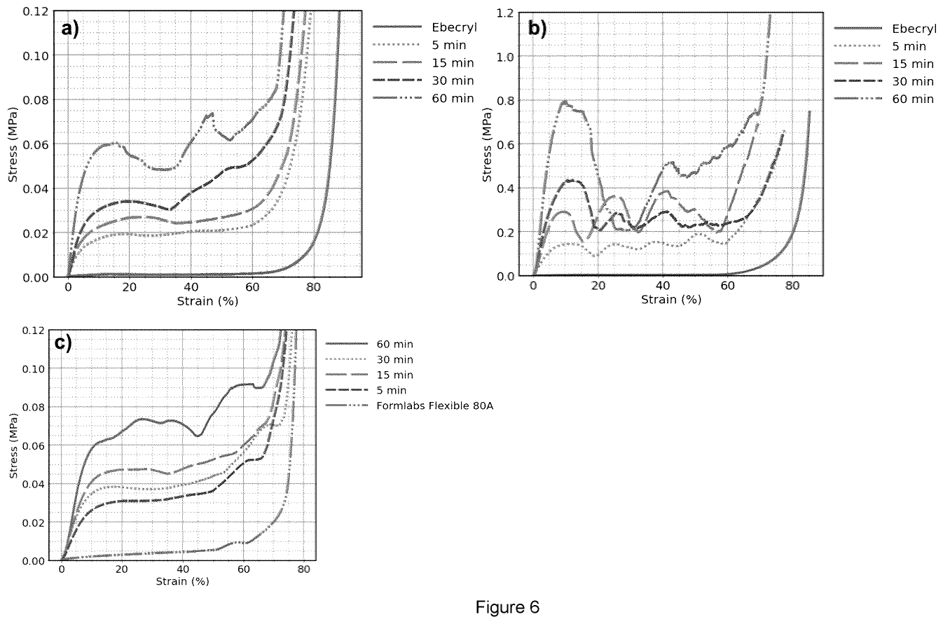

TABLE 3
Mechanical Properties from Compression Tests of 3D Printed IPN Lattices with Different Curing
Conditions of the Second Polymer (see FIG. 6 shows compression test stress-strain curves for
Kelvin and octet lattices composed of only HDDA as the first crosslinked polymer. Figure).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| IPN | Ebecryl/HEMA | 60 min at | 16.12 ± 0.13 | Kelvin | 2 × 2 × 2 | 0.07 | 13.28 ± 0.03 | 46.91 ± 1.43 | 98.12 ± 2.58 |
| | | 45° C. | | | | | | | |
| IPN | Ebecryl/HEMA | 60 min at | 16.52 ± 0.21 | Kelvin | 2 × 2 × 2 | 0.07 | 4.09 ± 0.03 | 45.87 ± 4.63 | 33.31 ± 0.23 |
| | | 60° C. | | | | | | | |
| IPN | Ebecryl/HEMA | 1000 flashes | 18.60 ± 0.04 | Kelvin | 2 × 2 × 2 | 0.07 | 8.86 ± 1.11 | 43.18 ± 0.80 | 71.6 ± 9.49 |
| IPN | Ebecryl/HDDA | 60 min at | 23.92 ± 1.08 | Kelvin | 2 × 2 × 2 | 0.07 | 11.49 ± 3.42 | 45.86 ± 4.02 | 118.06 ± 20.88 |
| | | 45° C. | | | | | | | |
| IPN | Ebecryl/HDDA | 60 min at | 20.85 ± 0.48 | Kelvin | 2 × 2 × 2 | 0.07 | 12.05 ± 0.11 | 47.76 ± 1.46 | 146.47 ± 16.79 |
| | | 65° C. | | | | | | | |
| IPN | Ebecryl/HEMA | 1000 flashes | 22.48 ± 0.47 | Kelvin | 2 × 2 × 2 | 0.07 | 35.13 ± 0.76 | 52.02 ± 2.68 | 527.44 ± 9.89 |

TABLE 4
Mechanical Properties from Compression Tests of 3D Printed IPN Lattices Compared
to Copolymer and First Crosslinked Polymer Lattices (see Figure).

| Polymer | | Resin 2 | Wt % | | | | Toughness at | Max | |
|---|---|---|---|---|---|---|---|---|---|
| Network | Polymer 1/ | Curing | Polymer 2/ | Lattice | # Unit | Relative | Densification | Efficiency | Stiffness |
| Type | Polymer 2 | Conditions | Precursor 2 | Type | Cells | Density | (kJ/m³) | (%) | (kPa) |
| Elastomer | Ebecryl/— | — | — | Octet | 2 × 2 × 2 | 0.14 | 1.87 ± 0.00 | 40.60 ± 0.02 | 22.79 ± 0.42 |
| Brittle | HDDA/— | — | — | Octet | 2 × 2 × 2 | 0.14 | 343.97 ± 14.52 | 22.55 ± 1.77 | 16968.33 ± 1829.25 |
| polymer | | | | | | | | | |
| IPN | Ebecryl/ | 60 min at | 16.36 ± 0.53 | Octet | 2 × 2 × 2 | 0.14 | 33.94 ± 2.16 | 47.51 ± 3.93 | 664.32 ± 37.98 |
| | HEMA | 45° C. | | | | | | | |
| IPN | Ebecryl/ | 60 min at | 21.47 ± 0.93 | Octet | 2 × 2 × 2 | 0.14 | 58.71 ± 11.77 | 51.80 ± 1.31 | 761.15 ± 145.99 |
| | HDDA | 65° C. | | | | | | | |
| Copolymer | Ebecryl + | — | 15 | Octet | 2 × 2 × 2 | 0.14 | 4.92 ± 0.32 | 36.26 ± 0.08 | 55.09 ± 1.81 |
| | HEMA/— | | | | | | | | |
| Copolymer | Ebecryl + | — | 21 | Octet | 2 × 2 × 2 | 0.14 | 30.46 ± 0.55 | 45.38 ± 1.39 | 324.47 ± 1.93 |
| | HDDA/— | | | | | | | | |
| Elastomer | Ebecryl/— | — | — | Kelvin | 2 × 2 × 2 | 0.07 | 1.01 ± 0.00 | 47.12 ± 1.22 | 10.37 ± 0.05 |
| Brittle | HDDA/— | — | — | Kelvin | 2 × 2 × 2 | 0.07 | 88.91 ± 3.97 | 33.53 ± 4.09 | 3731.51 ± 74.39 |
| Polymer | | | | | | | | | |
| IPN | Ebecryl/ | 60 min at | 15.01 ± 0.09 | Kelvin | 2 × 2 × 2 | 0.07 | 13.61 ± 0.08 | 46.91 ± 1.43 | 100.56 ± 2.31 |
| | HEMA | 45° C. | | | | | | | |
| IPN | Ebecryl/ | 60 min at | 20.85 ± 0.48 | Kelvin | 2 × 2 × 2 | 0.07 | 12.05 ± 0.11 | 47.76 ± 1.46 | 146.46 ± 16.78 |
| | HDDA | 65° C. | | | | | | | |
| Copolymer | Ebecryl + | — | 15 | Kelvin | 2 × 2 × 2 | 0.07 | 4.96 ± 0.20 | 38.03 ± 0.35 | 39.63 ± 2.00 |
| | HEMA/— | | | | | | | | |
| Copolymer | Ebecryl + | — | 21 | Kelvin | 2 × 2 × 2 | 0.07 | 8.80 ± 0.04 | 43.13 ± 0.33 | 101.86 ± 0.96 |
| | HDDA/— | | | | | | | | |

TABLE 5
Mechanical Properties from Compression Tests of 3D Printed IPN Lattices Compared
to Scaled Copolymer and First Crosslinked Polymer Lattices (see FIG. 10).

| | Polymer | Resin 2 | | | Wt % | | | Rela- | | | |
|---|---|---|---|---|---|---|---|---|---|---|---|
| Polymer | 1/ | Curing | | | Polymer | Lat- | | tive | Toughness at | Max | |
| Network | Polymer | Condi- | Scaling | Volume | 2/Pre- | tice | # Unit | Den- | Densification | Efficiency | Stiffness |
| Type | 2 | tions | Factor | (cm³) | cursor 2 | Type | Cells | sity | (kJ/m³) | (%) | (kPa) |
| IPN | Ebecryl/ | 60 min at | — | 19.20 ± 0.13 | 16.36 ± | Octet | 2 × 2 × 2 | 0.14 | 33.940 ± 2.16 | 47.51 ± 3.93 | 664.32 ± 37.98 |
| | HEMA | 45° C. | | | 0.53 | | | | | | |
| Elastomer | Ebecryl/— | — | — | 14.21 ± 0.17 | — | Octet | 2 × 2 × 2 | 0.14 | 1.87 ± 0.00 | 40.60 ± 0.02 | 22.79 ± 0.42 |
| Elastomer | Ebecryl/— | — | 1.05 | 17.57 ± 0.47 | — | Octet | 2 × 2 × 2 | 0.14 | 1.83 ± 0.03 | 45.05 ± 1.38 | 21.24 ± 0.14 |
| Scaled to | | | | | | | | | | | |
| HEMA IPN | | | | | | | | | | | |
| Copolymer | Ebecryl + | — | — | 15.40 ± 0.06 | 15 | Octet | 2 × 2 × 2 | 0.14 | 4.92 ± 0.32 | 36.26 ± 0.08 | 55.09 ± 1.81 |
| | HEMA/— | | | | | | | | | | |
| Copolymer | Ebecryl + | — | 1.07 | 18.79 ± 0.21 | 15 | Octet | 2 × 2 × 2 | 0.14 | 3.55 ± 0.18 | 37.12 ± 1.59 | 35.49 ± 3.13 |
| Scaled to | HEMA/— | | | | | | | | | | |
| HEMA IPN | | | | | | | | | | | |
| IPN | Ebecryl/ | 60 min at | — | 20.86 ± 0.19 | 21.47 ± | Octet | 2 × 2 × 2 | 0.14 | 58.71 ± 11.77 | 51.80 ± 1.31 | 761.15 ± 145.99 |
| | HDDA | 65° C. | | | 0.93 | | | | | | |
| Elastomer | Ebecryl/— | — | — | 14.21 ± 0.17 | — | Octet | 2 × 2 × 2 | 0.14 | 1.01 ± 0.00 | 47.11 ± 1.22 | 10.37 ± 0.05 |
| Elastomer | Ebecryl/— | — | 1.08 | 18.51 ± 0.26 | — | Octet | 2 × 2 × 2 | 0.14 | 1.96 ± 0.17 | 44.08 ± 1.37 | 22.75 ± 0.65 |
| Scaled to | | | | | | | | | | | |
| HDDA IPN | | | | | | | | | | | |
| Copolymer | Ebecryl + | — | — | 15.33 ± 0.00 | 21 | Octet | 2 × 2 × 2 | 0.14 | 30.46 ± 0.55 | 45.38 ± 1.39 | 324.47 ± 1.93 |
| | HDDA | | | | | | | | | | |
| Copolymer | Ebecryl + | — | 1.10 | 19.82 ± 0.11 | 24 | Octet | 2 × 2 × 2 | 0.14 | 55.61 ± 1.51 | 47.67 ± 0.48 | 573.34 ± 20.83 |
| Scaled to | HDDA/— | | | | | | | | | | |
| HDDA IPN | | | | | | | | | | | |
| IPN | Ebecryl/ | 60 min at | — | 17.61 ± 0.07 | 16.11 ± | Kel- | 2 × 2 × 2 | 0.07 | 13.61 ± 0.08 | 46.91 ± 1.43 | 100.56 ± 2.31 |
| | HEMA | 45° C. | | | 0.13 | vin | | | | | |
| Elastomer | Ebecryl/— | — | — | 14.21 ± 0.04 | — | Kel- | 2 × 2 × 2 | 0.07 | 1.01 ± 0.00 | 47.11 ± 1.22 | 10.37 ± 0.05 |
| | | | | | | vin | | | | | |
| Elastomer | Ebecryl/— | — | 1.03 | 15.89 ± 0.20 | — | Kel- | 2 × 2 × 2 | 0.07 | 0.71 ± 0.01 | 44.29 ± 0.44 | 8.49 ± 0.29 |
| Scaled to | | | | | | vin | | | | | |
| HEMA IPN | | | | | | | | | | | |
| Copolymer | Ebecryl + | — | — | 15.83 ± 0.10 | 15 | Kel- | 2 × 2 × 2 | 0.07 | 4.96 ± 0.20 | 38.03 ± 0.35 | 39.63 ± 2.00 |
| | HEMA/— | | | | | vin | | | | | |
| Copolymer | Ebecryl + | — | 1.03 | 16.89 ± 0.14 | 15 | Kel- | 2 × 2 × 2 | 0.07 | 1.54 ± 0.20 | 44.39 ± 0.12 | 15.82 ± 0.79 |
| Scaled to | HEMA/— | | | | | vin | | | | | |
| HEMA IPN | | | | | | | | | | | |
| IPN | Ebecryl/ | 60 min at | — | 21.27 ± 0.11 | 20.85 ± | Kel- | 2 × 2 × 2 | 0.07 | 12.05 ± 0.11 | 47.76 ± 1.46 | 146.47 ± 16.79 |
| | HDDA | 65° C. | | | 0.48 | vin | | | | | |
| Elastomer | Ebecryl/— | — | — | 14.21 ± 0.04 | — | Kel- | 2 × 2 × 2 | 0.07 | 1.01 ± 0.00 | 47.11 ± 1.22 | 10.37 ± 0.05 |
| | | | | | | vin | | | | | |
| Elastomer | Ebecryl/— | — | 1.09 | 19.07 ± 0.01 | — | Kel- | 2 × 2 × 2 | 0.07 | 0.68 ± 0.01 | 44.92 ± 0.06 | 7.78 ± 0.13 |
| Scaled to | | | | | | vin | | | | | |
| HDDA IPN | | | | | | | | | | | |
| Copolymer | Ebecryl + | — | — | 15.12 ± 0.01 | 21 | Kel- | 2 × 2 × 2 | 0.07 | 8.80 ± 0.04 | 43.13 ± 0.33 | 101.86 ± 0.96 |
| | HDDA/— | | | | | vin | | | | | |
| Copolymer | Ebecryl + | — | 1.12 | 21.01 ± 0.12 | 24 | Kel- | 2 × 2 × 2 | 0.07 | 10.74 ± 0.19 | 43.61 ± 1.96 | 143.67± 11.49 |
| Scaled to | HDDA/— | | | | | vin | | | | | |
| HDDA IPN | | | | | | | | | | | |

TABLE 6
Mechanical Properties from Compression Tests of 3D Printed IPN Hierarchical Lattices and Different Lattice Unit Cells (see FIG. 11).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| Elastomer | Formlabs Flexible | 1000 flashes | — | Kelvin-Octet | 1 × 1 × 1 | 0.06 | 0.23 | 40.19 | 3.19 |
| | 80A/— | | | | | | | | |
| IPN | Formlabs Flexible | 1000 flashes | 67.30 | Kelvin-Octet | 1 × 1 × 1 | 0.06 | 35.21 | 50.81 | 566.99 |
| | 80A/HEMA | | | | | | | | |
| Elastomer | Formlabs Flexible | 1000 flashes | — | Octet-Octet | 1 × 1 × 1 | 0.10 | 0.52 | 41.84 | 17.70 |
| | 80A/— | | | | | | | | |
| IPN | Formlabs Flexible | 1000 flashes | 69.02 | Octet-Octet | 1 × 1 × 1 | 0.10 | 52.61 | 40.02 | 1320.08 |
| | 80A/HEMA | | | | | | | | |
| Elastomer | Ebecryl/— | 1000 flashes | — | Schwarz | 2 × 2 × 2 | 0.137 | 2.98 ± 0.08 | 38.11 ± 0.08 | 28.41 ± 0.58 |
| IPN | Ebecryl/HEMA | 1000 flashes | 18.64 ± 0.76 | Schwarz | 2 × 2 × 2 | 0.137 | 23.95 ± 0.07 | 45.67 ± 1.10 | 269.17 ± 53.07 |

TABLE 7
Mechanical Properties from Compression Tests of 3D Printed IPN Lattices with Different Number of Unit Cells in the Lattice (see FIG. 12).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| Elastomer | Ebecryl/— | 1000 flashes | — | Octet | 2 × 2 × 2 | 0.15 | 2.31 ± 0.18 | 42.50 ± 2.06 | 26.79 ± 0.62 |
| IPN | Ebecryl/HEMA | 1000 flashes | 22.40 ± 0.49 | Octet | 2 × 2 × 2 | 0.15 | 83.67 ± 11.83 | 49.20 ± 0.80 | 947.42 ± 257.59 |
| Elastomer | Ebecryl/— | 1000 flashes | — | Octet | 4 × 4 × 4 | 0.15 | 2.38 ± 0.00 | 37.74 ± 0.71 | 37.74 ± 1.26 |
| IPN | Ebecryl/HEMA | 1000 flashes | 34.93 ± 3.96 | Octet | 4 × 4 × 4 | 0.15 | 137.88 ± 2.66 | 34.16 ± 0.25 | 1879.88 ± 354.23 |
| Elastomer | Ebecryl/— | 1000 flashes | — | Kelvin | 2 × 2 × 2 | 0.15 | 3.22 ± 0.23 | 37.37 ± 0.33 | 33.48 ± 1.30 |
| IPN | Ebecryl/HEMA | 1000 flashes | 18.69 ± 0.81 | Kelvin | 2 × 2 × 2 | 0.15 | 26.14 ± 11.68 | 33.11 ± 1.18 | 196.62 ± 87.05 |
| Elastomer | Ebecryl/— | 1000 flashes | — | Kelvin | 7 × 7 × 7 | 0.15 | 5.96 ± 0.14 | 40.47 ± 0.58 | 61.91 ± 0.97 |
| IPN | Ebecryl/HEMA | 1000 flashes | 46.51 ± 3.10 | Kelvin | 7 × 7 × 7 | 0.15 | 65.28 ± 13.98 | 31.76 ± 6.00 | 1125.12 ± 469.04 |

TABLE 8
Mechanical Properties from Compression Tests of 3D Printed IPN Lattices with Different Types of Second Polymer (see FIG. 13).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| IPN | Ebecryl/HEMA | 60 min at 65° C. | 14.62 ± 0.70 | Kelvin | 2 × 2 × 2 | 0.07 | 13.37 ± 2.00 | 47.36 ± 3.05 | 119.42 ± 42.02 |
| IPN | Ebecryl/HDDA | 60 min at 45° C. | 23.92 ± 0.76 | Kelvin | 2 × 2 × 2 | 0.07 | 114.88 ± 24.15 | 45.86 ± 2.85 | 118.06 ± 14.76 |
| IPN | Ebecryl/EMA | 60 min at 65° C. | 13.24 ± 1.31 | Kelvin | 2 × 2 × 2 | 0.07 | 6.25 ± 1.84 | 48.94 ± 4.31 | 57.08 ± 16.67 |
| IPN | Ebecryl/HPMA | 60 min at 65° C. | 14.51 ± 1.17 | Kelvin | 2 × 2 × 2 | 0.07 | 16.39 ± 3.21 | 49.05 ± 0.79 | 214.36 ± 87.46 |

TABLE 9
Mechanical Properties from Compression Tests of 3D Printed IPN Lattices with Different First Polymer (see FIG. 14).

| Polymer | | Resin 2 | | | | | Toughness at | Max | |
|---|---|---|---|---|---|---|---|---|---|
| Network | Polymer 1/ | Curing | Wt % | Lattice | # Unit | Relative | Densification | Efficiency | Stiffness |
| Type | Polymer 2 | Conditions | Polymer 2 | Type | Cells | Density | (kJ/m³) | (%) | (kPa) |
| Elastomer | Ebecryl 242N/— | — | — | Octet | 2 × 2 × 2 | 0.14 | 107.37 ± 3.22 | 48.57 ± 0.12 | 1277.33 ± 50.85 |
| IPN | Ebecryl 242N/ | 60 min at | 12.38 ± 0.63 | Octet | 2 × 2 × 2 | 0.14 | 152.04 ± 10.09 | 50.88 ± 1.91 | 1874.94 ± 50.96 |
| | HEMA | 45° C. | | | | | | | |
| IPN | Ebecryl 242N/ | 60 min at | 17.75 ± 0.25 | Octet | 2 × 2 × 2 | 0.14 | 156.37 ± 12.83 | 49.31 ± 1.05 | 1889.23 ± 104.38 |
| | HDDA | 65° C. | | | | | | | |
| Elastomer | CN9021/— | — | — | Octet | 2 × 2 × 2 | 0.14 | 26.64 ± 0.95 | 49.61 ± 1.61 | 411.99 ± 18.18 |
| IPN | CN9021/HEMA | 60 min at | 19.24 ± 0.91 | Octet | 2 × 2 × 2 | 0.14 | 59.45 ± 0.87 | 50.84 ± 3.66 | 803.23 ± 83.65 |
| | | 45° C. | | | | | | | |
| IPN | CN9021/HDDA | 60 min at | 21.26 ± 0.98 | Octet | 2 × 2 × 2 | 0.14 | 71.67 ± 11.01 | 50.97 ± 2.34 | 1148.74 ± 210.23 |
| | | 65° C. | | | | | | | |
| Elastomer | CN973J75/— | — | — | Octet | 2 × 2 × 2 | 0.14 | 83.46 ± 1.62 | 49.04 ± 0.06 | 910.99 ± 46.16 |
| IPN | CN973J75/ | 60 min at | 11.58 ± 0.62 | Octet | 2 × 2 × 2 | 0.14 | 195.59 ± 35.99 | 47.68 ± 4.87 | 2240.11 ± 311.49 |
| | HEMA | 45° C. | | | | | | | |
| IPN | CN973J75/ | 60 min at | 16.55 ± 0.25 | Octet | 2 × 2 × 2 | 0.14 | 128.50 ± 10.44 | 47.30 ± 1.79 | 1513.71 ± 96.69 |
| | HDDA | 65° C. | | | | | | | |
| Elastomer | Ebecryl 242N/— | — | — | Kelvin | 2 × 2 × 2 | 0.07 | 22.54 ± 1.96 | 38.24 ± 1.60 | 223.21 ± 10.74 |
| IPN | Ebecryl 242N/ | 60 min at | 11.83 ± 0.20 | Kelvin | 2 × 2 × 2 | 0.07 | 53.56 ± 7.98 | 43.60 ± 2.50 | 527.26 ± 9.86 |
| | HEMA | 45° C. | | | | | | | |
| IPN | Ebecryl 242N/ | 60 min at | 16.78 ± 0.37 | Kelvin | 2 × 2 × 2 | 0.07 | 50.05 ± 1.31 | 50.53 ± 1.92 | 508.94 ± 21.23 |
| | HDDA | 65° C. | | | | | | | |
| Elastomer | CN9021/— | — | — | Kelvin | 2 × 2 × 2 | 0.07 | 11.11 ± 0.59 | 48.40 ± 0.56 | 144.36 ± 4.51 |
| IPN | CN9021/HEMA | 60 min at | 17.78 ± 0.79 | Kelvin | 2 × 2 × 2 | 0.07 | 19.13 ± 0.30 | 55.08 ± 0.66 | 217.41 ± 2.21 |
| | | 45° C. | | | | | | | |
| IPN | CN9021/HDDA | 60 min at | 20.18 ± 0.29 | Kelvin | 2 × 2 × 2 | 0.07 | 22.23 ± 8.43 | 52.09 ± 2.14 | 268.74 ± 67.20 |
| | | 65° C. | | | | | | | |
| Elastomer | CN973J75/— | — | — | Kelvin | 2 × 2 × 2 | 0.07 | 25.10 ± 1.32 | 47.88 ± 5.25 | 199.71 ± 0.09 |
| IPN | CN973J75/ | 60 min at | 11.19 ± 1.24 | Kelvin | 2 × 2 × 2 | 0.07 | 65.60 ± 0.43 | 43.28 ± 3.70 | 507.53 ± 37.11 |
| | HEMA | 45° C. | | | | | | | |
| IPN | CN973J75/ | 60 min at | 16.90 ± 0.41 | Kelvin | 2 × 2 × 2 | 0.07 | 51.13 ± 2.39 | 54.08 ± 1.03 | 443.67 ± 30.79 |
| | HDDA | 65° C. | | | | | | | |

1. A material having a three-dimensional shape comprising:
a) a first phase comprising a first crosslinked polymer; and
b) a second phase comprising a concentration gradient interpenetrating polymer network comprising the first crosslinked polymer and a second polymer, the concentration gradient interpenetrating polymer network comprising the second polymer at a decreasing concentration along at least one axis within the first phase; and
the three-dimensional shape of the material aids in energy absorption.

2. (canceled)

3. (canceled)

4. (canceled)

5. The material of claim 1, wherein the first crosslinked polymer is an elastomeric polymer, and the elastomeric polymer is a polyurethane, polysiloxane (silicone), poly(meth)acrylate, polyether, polyamide, polyester, polythiol, or a combination thereof.

6. (canceled)

7. The material of claim 5, wherein the polyurethane is a urethane-based acrylate elastomer or an aromatic urethane-based acrylate elastomer.

8. (canceled)

9. (canceled)

10. (canceled)

11. (canceled)

12. The material of claim 1, wherein the first crosslinked polymer is an elastomeric polymer, and the elastomeric polymer is a liquid crystal elastomer.

13. The material of claim 12, wherein the liquid crystal elastomer is formed from a precursor material comprising a liquid crystal mesogen and a chain extender.

14. The material of claim 13, wherein the liquid crystal mesogen is a diacrylate and the chain extender is a dithiol and/or amine,

15. The material of claim 14, wherein the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; 4-[3-[(1-oxo-2-propen-1-yl)oxy]propoxy]-1,1′-(1,4-phenylene) ester benzoic acid.

16. The material of claim 13, wherein the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

17. The material of claim 16, wherein the second polymer is a poly(meth)acrylate, polyurethane, polysiloxane (silicone), polyether, polyamide, polyester, polythiol, or combination of.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. The material according to claim 1, wherein the concentration gradient interpenetrating polymer network is a continuous concentration gradient interpenetrating polymer network.

31. (canceled)

32. A process for preparing a material having a three-dimensional shape, the process comprising:
a) 3D-printing a first cross-linked polymer in the form of the three-dimensional shape to form a first phase comprising the first crosslinked polymer;
b) exposing at least a portion of the first cross-linked polymer in the form of the three-dimensional shape to a liquid precursor comprising second polymer precursors, wherein the second polymer precursors diffuse into the first cross-linked polymer to obtain the first cross-linked polymer in the form of the three-dimensional shape with a decreasing concentration gradient of the second polymer precursor in the first cross-linked polymer to form a second phase within the first phase;
c) polymerizing the second polymer precursors to form the second polymer and to obtain the material having a concentration gradient interpenetrating polymer network.

33. The process of claim 32, wherein the 3D-printed first cross-linked polymer is formed by:
i) polymerizing and cross-linking first polymer precursors in the presence of a cross-linker and a photoinitiator, by exposing the first polymer precursors to light radiation during three-dimensional printing to obtain the first cross-linked polymer in the form of the three-dimensional shape; or
ii) extruding first polymer precursors, in the presence of a cross-linker, through a nozzle to obtain the first crosslinked polymer in the form of the three-dimensional shape.

34. The process according to claim 33, wherein the light radiation is UV light, visible light or near-infrared light.

35. The process according to claim 32, wherein in step (b), the first cross-linked polymer in the form of the three-dimensional shape is soaked or immersed in the liquid precursor mixture.

36. The process according to claim 32, wherein the second polymer precursors in step (c) are polymerized by exposing to radiation.

37. (canceled)

38. (canceled)

39. (canceled)

40. (canceled)

41. The process of claim 32, wherein the first cross-linked polymer is an elastomeric polymer, wherein the elastomeric polymer is a polyurethane, polysiloxane (silicone), poly(meth)acrylate, polyether, polyamide, polyester, polythiol, or a combination thereof.

42. (canceled)

43. (canceled)

44. (canceled)

45. (canceled)

46. (canceled)

47. (canceled)

48. The process of claim 32, wherein the first crosslinked polymer is an elastomeric polymer, and the elastomeric polymer is a liquid crystal elastomer.

49. The process of claim 48, wherein the liquid crystal elastomer is formed from a precursor material comprising a liquid crystal mesogen and a chain extender.

50. The process of claim 49, wherein the liquid crystal mesogen is a diacrylate and the chain extender is a dithiol and/or amine,

51. The process of claim 50, wherein the liquid crystal mesogen is 1,4-bis-[4-(6-acryloyloxyhexyloxy)benzoyloxy]-2-methylbenzene; 1,4-bis-[4-(3-acryloyloxypropyloxy)benzoyloxy]-2-methylbenzene; 4,4′-bis[9-(acryloyloxy)nonyloxy]azobenzene, benzoic acid; 4-[2-[(1-oxo-2-propen-1-yl)-oxy]ethoxy]-, 4-[2-[(1-oxo-2-propen-1-yl)oxy]ethoxy]phenyl ester; 4-((6-((1-oxo-2-propen-1-yl)oxy)hexyl)oxy)benzoic acid-1,1′-(1,4-phenylene) ester; 4-[4-[(1-oxo-2-propen-1-yl)oxy]butoxy]-1,1′-(2-methyl-1,4-phenylene)ester benzoic acid; or 4-[3-[(1-oxo-2-propen-1-yl)oxy]propoxy]-1,1′-(1,4-phenylene) ester benzoic acid.

52. The process of claim 49, wherein the liquid crystal elastomer is chain extended with 2,2′-(ethylenedioxy) diethanethiol, 1,3-propanedithiol, glycol di(3-mercaptoprpionate), allyl dithiol, pentaerythritol tetrakis (3-mercaptoprpionate), n-butylamine, 1,5-diaminopentane, furfurylamine, 5-amino-1-pentanol, 1,3,5-triallyl-1,3,5-triazine,2,4,6(1H,3H,5H)-trione.

53. The process according to claim 32, wherein the second polymer precursors are monomers of the second polymer.

54. The process of claim 32, wherein the second polymer is a poly(meth)acrylate, polyurethane, polysiloxane (silicone), polyether, polyamide, polyester, polythiol, copolymers thereof or combinations thereof.

55. (canceled)

56. (canceled)

57. (canceled)

58. (canceled)

59. (canceled)

60. The process of claim 32, wherein the material is an energy absorbing material.

61. The process of claim 32, wherein the concentration gradient interpenetrating polymer network is a continuous concentration gradient interpenetrating polymer network.

62. (canceled)
